(19) United States
(12) Patent Application Publication
(10) Pub. No.: US 2015/0019325 A1
(43) Pub. Date: Jan. 15, 2015

(54) ADVERTISEMENT DELIVERY METHOD, APPARATUS, AND SYSTEM

(71) Applicant: Huawei Technologies Co., Ltd., Shenzhen (CN)

(72) Inventors: Zhengbing Li, Shenzhen (CN); Jiachun Du, Shenzhen (CN); Xun Hu, Santa Clara, CA (US)

(21) Appl. No.: 14/474,548

(22) Filed: Sep. 2, 2014

Related U.S. Application Data
(63) Continuation of application No. PCT/CN2013/070219, filed on Jan. 8, 2013.

(30) Foreign Application Priority Data
Mar. 2, 2012 (CN) 201210052919.6

(51) Int. Cl. G06Q 30/02

(52) U.S. Cl. CPC G06Q 30/0271; G06Q 30/0269; G06Q 30/0243
USPC 705/14.42; 705/14.66; 705/14.67

(57) ABSTRACT

Embodiments of the present invention provide an advertisement delivery method, apparatus, and system, which can implement personalized advertising network allocation, so that a selected advertising network meets a preference of a user in real time. The method includes: sending a first message including user information to an advertising platform; receiving a second message sent by the advertising platform, where the second message includes delivery information that is determined by the advertising platform according to the user information; and performing advertisement delivery according to the delivery information. According to the advertisement delivery method, apparatus, and system in the embodiments of the present invention, an advertising network is selected with reference to user information, so that the selected advertising network can meet a preference of a user, thereby implementing personalized advertising network allocation.

### CROSS-REFERENCE TO RELATED APPLICATIONS

This application is a continuation of International Application No. PCT/CN2013/070219, filed on Jan. 8, 2013, which claims priority to Chinese Patent Application No. 201210052919.6, filed on Mar. 2, 2012, both of which are hereby incorporated by reference in their entireties.

### TECHNICAL FIELD

Embodiments of the present invention relate to the field of advertisements, and in particular, to an advertisement delivery method, apparatus, and system.

### BACKGROUND

Due to lack of an independent advertiser, small and medium-sized media merchants or application developers need to deliver an advertisement of an advertising network (Advertising network, also referred to a third party advertising network or an advertisement alliance). By binding advertisements of multiple advertising networks in one advertisement space of an application, a filling rate of the advertisements can be improved, and revenues of an advertiser can be increased. How to properly allocate a ratio of each advertising network becomes an issue that concerns the small and medium-sized media merchants or the application developers. Currently, there is a known method, in which an application developer sets an allocation proportion of advertisement display traffic in each advertising network, that is, the allocation proportion is dynamically optimized at a server, and then, the set allocation proportion is synchronized to a client that has an application installed.

However, such a method cannot meet a preference of a user for different advertising networks, and cannot implement personalized advertising network allocation.

### SUMMARY

Embodiments of the present invention provide an advertisement delivery method and apparatus, which can implement personalized advertising network allocation, so that a selected advertising network meets a preference of a user in real time.

According to one aspect, an advertisement delivery method is provided, where the method includes: sending a first message including user information to an advertising platform; receiving a second message sent by the advertising platform, where the second message includes delivery information that is determined by the advertising platform according to the user information; and performing advertisement delivery according to the delivery information.

According to another aspect, an advertisement delivery method is provided, where the method includes: receiving a first message sent by a client and including user information; determining network information and first allocation information according to the user information, where the network information is used to indicate at least two candidate advertising networks, and the first allocation information is used to indicate allocation proportions of advertisement display traffic in the at least two candidate advertising networks; determining delivery information according to the network information and the first allocation information; and sending a second message including the delivery information to the client, so that the client performs advertisement delivery according to the delivery information.

According to still another aspect, an advertisement delivery method is provided, where the method includes: receiving an delivery request message sent by an advertising platform, where the delivery request message includes network information and proportion allocation information that are determined by the advertising platform, the network information is used to indicate at least two candidate advertising networks, and the proportion allocation information is used to indicate allocation proportions of advertisement display traffic in the at least two candidate advertising networks; determining an initial delivery advertising network from the at least two candidate advertising networks according to the network information and the proportion allocation information, and obtaining at least one advertisement from the initial delivery advertising network to perform delivery; obtaining first user operation information; updating the proportion allocation information according to the first user operation information; and determining an updated delivery advertising network from the at least two candidate advertising networks according to the updated proportion allocation information, and obtaining at least one advertisement from the updated delivery advertising network to perform delivery.

According to still another aspect, an advertisement delivery apparatus is provided, where the apparatus includes: a sending unit, configured to send a first message including user information to an advertising platform; a receiving unit, configured to receive a second message sent by the advertising platform, where the second message includes delivery information that is determined by the advertising platform according to the user information; and a delivering unit, configured to perform advertisement delivery according to the delivery information.

According to still another aspect, an advertisement delivery apparatus is provided, where the apparatus includes: a receiving unit, configured to receive a first message sent by a client and including user information; a determining unit, configured to determine network information and first allocation information according to the user information, where the network information is used to indicate at least two candidate advertising networks, and the first allocation information is used to indicate allocation proportions of advertisement display traffic in the at least two candidate advertising networks; and configured to determine delivery information according to the network information and the first allocation information; and a sending unit, configured to send a second message including the delivery information to the client, so that the client performs advertisement delivery according to the delivery information.

According to still another aspect, an advertisement delivery apparatus is provided, where the apparatus includes: a receiving unit, configured to receive a delivery request message sent by an advertising platform, where the delivery request message includes network information and first allocation information that are determined by the advertising platform, the network information is used to indicate at least two candidate advertising networks, and the first allocation information is used to indicate allocation proportions of advertisement display traffic in the at least two candidate advertising networks; a delivering unit, configured to determine an initial delivery advertising network from the at least two candidate advertising networks according to the network information and the first allocation information, and obtain at least one advertisement from the initial delivery advertising network to perform delivery; an obtaining unit, configured to obtain first user operation information; and an updating unit, configured to update the first allocation information according to the first user operation information, where the delivering unit is further configured to determine an updated delivery advertising network from the at least two candidate advertising networks according to the updated first allocation information, and obtain at least one advertisement from the updated delivery advertising network to perform delivery.

According to still another aspect, an advertisement delivery system is provided, where the system includes: a client and an advertising platform, where the client includes: a sending unit, configured to send a first message including user information to the advertising platform; a receiving unit, configured to receive a second message sent by the advertising platform, where the second message includes delivery information that is determined by the advertising platform according to the user information; and a delivering unit, configured to perform advertisement delivery according to the delivery information; and the advertising platform includes: a receiving unit, configured to receive the first message sent by the client and including the user information; a determining unit, configured to determine network information and first allocation information according to the user information, where the network information is used to indicate at least two candidate advertising networks, and the first allocation information is used to indicate allocation proportions of advertisement display traffic in the at least two candidate advertising networks; and configured to determine the delivery information according to the network information and the first allocation information; and a sending unit, configured to send the second message including the delivery information to the client, so that the client performs advertisement delivery according to the delivery information.

According to the embodiments of the present invention, an advertising network is selected with reference to user information, and/or information about the advertising network, such as a delivery proportion, is updated in real time at a client, so that the selected advertising network can meet a preference of a user, thereby implementing personalized advertising network allocation.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of an advertisement delivery method according to an embodiment of the present invention;

FIG. 2 is a schematic flowchart of an advertisement delivery method according to another embodiment of the present invention;

FIG. 3 is a schematic flowchart of an advertisement delivery method according to still another embodiment of the present invention;

FIG. 4 is a schematic block diagram of an advertisement delivery apparatus according to an embodiment of the present invention;

FIG. 5 is a schematic block diagram of an advertisement delivery apparatus according to another embodiment of the present invention;

FIG. 6 is a schematic block diagram of an advertisement delivery apparatus according to still another embodiment of the present invention; and

FIG. 7 is a schematic block diagram of an advertisement delivery system according to an embodiment of the present invention.

### DETAILED DESCRIPTION

The following clearly describes the technical solutions in the embodiments of the present invention with reference to the accompanying drawings in the embodiments of the present invention. Apparently, the described embodiments are a part of the embodiments of the present invention rather than all of the embodiments. All other embodiments obtained by a person of ordinary skill in the art based on the embodiments of the present invention without creative efforts shall fall within the protection scope of the present invention.

An advertising platform may also be referred to as an advertising network optimization platform or a server, and is used to allocate an advertising network for a client. A media merchant may register an account with the advertising platform, manage an advertisement space, set an advertising network corresponding to the advertisement space, set an optimization parameter of the advertising network corresponding to the advertisement space, and the like, and the advertising network may report the number of times that an advertisement is clicked, the number of times that the advertisement is displayed, and the like to the advertising platform. Therefore, the advertising platform may determine an advertisement delivery policy according to the advertisement space and maintains the delivery policy.

In the embodiments of the present invention, the advertisement delivery policy may include a candidate advertising network and an allocation proportion of advertisement display traffic in each candidate advertising network.

The client may also be referred to as a user equipment, and is a terminal device for delivering an advertisement to a user. A window by using which the client performs delivery may be an application, or may be a browser, and a content website accessed by using the browser needs to optimize the advertising network by using the advertising platform.

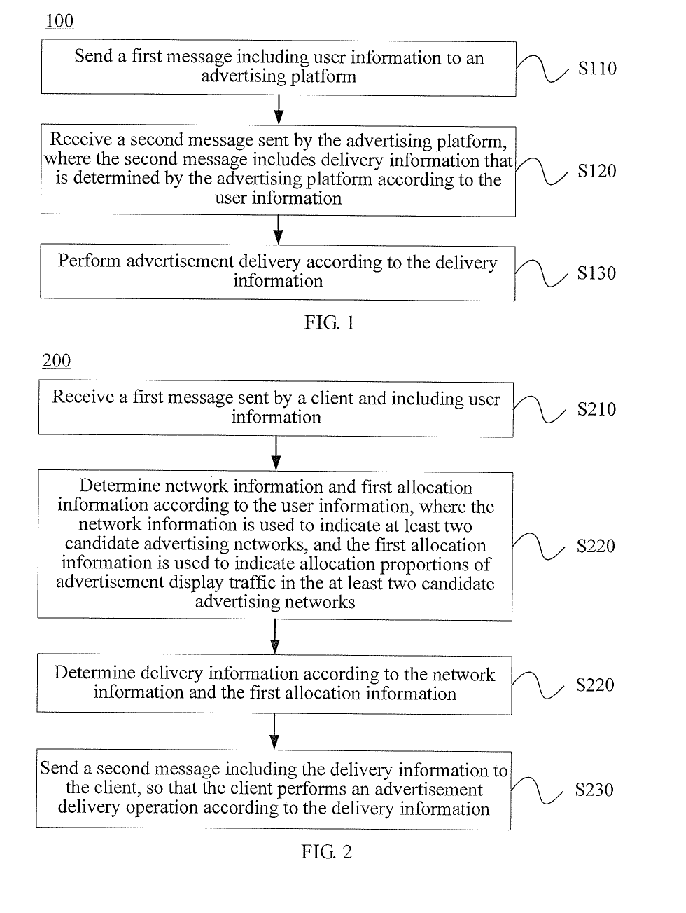

FIG. 1 shows a schematic flowchart of an advertisement delivery method 100 according to an embodiment of the present invention, which is described from the perspective of a client. As shown in FIG. 1, the method 100 includes:

S110: Send a first message including user information to an advertising platform.

S120: Receive a second message sent by the advertising platform, where the second message includes delivery information that is determined by the advertising platform according to the user information.

S130: Perform advertisement delivery according to the delivery information.

In S110, for example, when a user starts an application or browses a content website by using a browser, the client may send the first message including the user information (for example, a user ID, a user age, a user gender, and a user location) to the advertising platform.

In addition, after receiving the first message, the advertising platform may generate an inventory according to the user information (for example, a user ID, a user age, a user gender, and a user location) and advertisement space information (for example, an application ID, an advertisement space ID, an advertisement space size, and an advertisement space category), so that the advertising platform can determine a delivery policy corresponding to the inventory (including the user information), according to the inventory, from a delivery policy database generated based on a correspondence between the inventory and the delivery policy, and generate a policy file, where the policy file records network information used to indicate at least two candidate advertising networks and first allocation information used to indicate allocation proportions of advertisement display traffic in the at least two candidate advertising networks.

Specifically, the advertising platform may maintain one user information database. User information in the user information database may be provided by a developer of an application of the client, may also be reported by a user, and may further be provided by a third party server. Therefore, the advertising platform may further query, according to a specified condition (such as a user ID), the user information stored in the user information database. Therefore, when the user information included in the first message is the user ID, and if the user ID is stored in the user information database, the advertising platform may determine other related information about the user according to the following Table 1. Therefore, the advertising platform may combine the user information (for example, a user ID, a user age, a user gender, and a user location) with the advertisement space information (for example, the application ID, the advertisement space ID, the advertisement space size, and the advertisement space category) to generate the inventory.

TABLE 1

| User ID | Age | Gender | Hobby | Region |
|---|---|---|---|---|
| userid_1 | 15 | Male | Sports | Nanjing |
| userid_2 | 16 | Female | Literature | Guangzhou |
| userid_3 | 14 | Male | News | Shenzhen |

In addition, the advertising platform may further determine a delivery policy meeting a preference of the user, according to the inventory (including the user information, for example, the user ID), from a delivery policy database (as shown in Table 2) maintained by the advertising platform and used to indicate the correspondence between the inventory (including the user information, for example, a combination of an application ID, the advertisement space ID, and the user ID) and the delivery policy. And the advertising platform generates a policy file, where the inventory and the advertising network distribution may be stored in a manner of a multi-dimensional database (for example, fastbit) for query. The following Table 2 shows an example of the delivery policy database.

TABLE 2

| | | | | Advertising network distribution | | | | |
|---|---|---|---|---|---|---|---|---|
| | | | | Advertising | | | | |
| Application | Advertisement | | | network | | | | |
| ID | space ID | User ID | β | vector | w | p | Display | Click |
| 1 | adid_1 | userid_1 | 0.8 | (ADN1, | (0.333, | (0.333, | — | — |
| | | | | ADN2, | 0.333, | 0.333, | | |
| | | | | ADN3) | 0.333) | 0.333) | | |
| 1 | adid_1 | userid_2 | 0.8 | (ADN1, | (0.333, | (0.333, | — | — |
| | | | | ADN2, | 0.333, | 0.333, | | |
| | | | | ADN3) | 0.333) | 0.333) | | |
| 1 | adid_1 | userid_3 | 0.8 | (ADN1, | (0.333, | (0.333, | — | — |
| | | | | ADN2, | 0.333, | 0.333, | | |
| | | | | ADN3) | 0.333) | 0.333) | | |

ADN1, ADN2, and ADN3 are optional advertising networks, p is an allocation proportion of the advertisement display traffic in each advertising network (a distribution of the advertising network), β is an adjustable parameter in a Hedge algorithm, and in the Hedge algorithm, w is used to express the distribution of the allocation proportion of the advertising network p.

The Hedge algorithm is used to solve the problem of allocating a proportion of each policy on line, and is described as follows:

1. There are N optional allocation policies in total, and in total, there are T opportunities of allocating a ratio for these policies.

2. When t is allocated each time, a distribution p^{t} is determined, and it is determined that an allocation proportion for each policy is pᵢ^{t}, (i=1, 2, . . . , N represents a policy number, and t represents an allocated sequence number).

3. A loss l^{t} generated after each allocation is calculated, and a next distribution pⁱ⁺¹ is adjusted according to the loss.

4. If a ratio is evenly allocated for each policy initially,

$${L}_{Hedge ( β )} \leq \frac{{min}_{i} {L}_{i} ln ( 1 / β ) + ln N}{1 - β} , where$$

$${L}_{i} = {\sum }_{i = 1}^{T} {l}_{i}^{t}$$

represents a loss of a policy i during T times of allocations, β is the adjustable parameter, and

$${L}_{Hedge ( β )} = {\sum }_{i = 1}^{T} {P}^{t} {l}^{t}$$

represents all losses.

The Hedge algorithm is further described as follows:

5. The algorithm maintains one vector w^{t}=(w₁^{t}, . . . , w_{N}^{t}), an initial value may be set to

$${w}_{i}^{1} = 1 / N , \\ and$$

$${\sum }_{i = 1}^{N} {w}_{i}^{1} = 1.$$

6. A distribution

$${p}^{t} = \frac{{w}^{t}}{{\sum }_{i = 1}^{N} {w}_{i}^{t}}$$

is set according to the vector w^{t}.

7. A loss l^{t} generated during a t^{th} allocation is calculated according to the distribution p^{t}.

8. A vector wᵢ^{t+1}=wᵢ^{t}·U_{β}(lᵢ^{t}) is updated, where U_{β} is a [0,1]→[0,1] function, βε[0,1], and β^{γ}≦U_{β}≦1−(1−β)γ.

9. A (t+1)^{th} allocation p^{t+1} is calculated by using the vector wᵢ^{t+1}.

In the embodiment of the present invention, the advertising network is used as a selectable policy.

In addition, in the embodiment of the present invention, as an example rather than a limitation, the policy file may be represented as the following policy file 1.

Policy file 1
<app id=“1”>

<algrithm name=“hedge”>

<version>123</version>
<adid>adid_1</adid>
<adnetworks>ADN1, ADN2, ADN3</adnetworks>
<w>0.333, 0.333, 0.333</w>
<beta>0.8</beta>

</algrithm>

</app>

It should be understood that, representations of the user information database, the delivery policy database, and the policy file that are listed above and a parameter and a numerical value that are included therein are only exemplary descriptions of the present invention, and the present invention is not limited thereto.

In the embodiment of the present invention, the advertising platform may directly send the policy file to the client, so that the client selects an advertising network according to the policy file, and obtains an advertisement from the selected advertising network (case 1); the advertising platform may also select one advertising network according to the policy file, and send an interface file of the advertising network to the client, so that the client directly obtains an advertisement from the advertising network corresponding to the interface file (case 2); and the advertising platform may further select one or more advertising networks according to the policy file, and obtain at least two advertisements from the selected advertising networks, and notify the client of an allocation proportion of the advertisement display traffic in each advertisement, so that the client delivers an advertisement according to the allocation proportion (case 3). These three cases are described respectively in the following.

Case 1

Optionally, in the embodiment of the present invention, the performing advertisement delivery according to the delivery information includes:

determining a first delivery advertising network from at least two candidate advertising networks according to network information and first allocation information that are included in the delivery information, and obtaining at least one advertisement from the first delivery advertising network to perform delivery, where the network information is used to indicate the at least two candidate advertising networks, the first allocation information is used to indicate allocation proportions of advertisement display traffic in the at least two candidate advertising networks, and the network information and the first allocation information are determined by the advertising platform according to the user information.

Specifically, the advertising platform may send the policy file to the client, where the policy file records the network information used to indicate the at least two candidate advertising networks (for example, information that indicates the three advertising networks: ADN1, ADN2, and ADN3 in the policy file), and the first allocation information used to indicate the allocation proportion of the advertisement display traffic (briefly referred to as traffic in the following) in each advertising network (for example, 0.333, 0.333, and 0.333 in the policy file represent initial weights used to calculate allocation proportions of the traffic in the three advertising networks: ADN1, ADN2, and ADN3, and in the following, the calculation process is described in detail).

In S120, the client may determine the candidate advertising networks and the allocation proportion of the traffic in each candidate advertising network according to parameters in the policy file. Specifically, the client may determine an initial weight w¹=(0.333,0.333,0.333) in the Hedge algorithm, and determine the adjustable parameter β=0.8 and U_{β}(lᵢ^{t})=0.8^{l}^{ᵢ}^{^{t}}: in the Hedge algorithm. According to a formula 1, it is determined that delivery proportions of ADN1, ADN2, and ADN3 are p¹=(0.333,0.333,0.333) (representing that traffic allocation of ADN1, ADN2, and ADN3 each accounts for ⅓, that is, probabilities that delivery is performed in ADN1, ADN2, and ADN3 or probabilities that ADN1, ADN2, and ADN3 are selected are each 33.3%):

$${p}^{t} = \frac{{w}^{t}}{{\sum }_{i = 1}^{N} {w}_{i}^{t}} \qquad Formula 1$$

In S130, the client selects, according to the allocation proportions, from the candidate advertising networks (ADN1, ADN2, and ADN3), an advertising network for delivering an advertisement, to perform advertisement delivery.

According to the advertisement delivery method in the embodiment of the present invention, an advertising network is selected with reference to user information, so that a selected advertising network can meet a preference of a user, thereby implementing personalized advertising network allocation.

Optionally, in the embodiment of the present invention, after the obtaining at least one advertisement from the first delivery advertising network to perform delivery, the method further includes:

obtaining first user operation information;

updating the first allocation information according to the first user operation information; and

determining a second delivery advertising network from the at least two candidate advertising networks according to the network information and the updated first allocation information, and obtaining at least one advertisement from the second delivery advertising network to perform delivery.

Specifically, after delivering the advertisement, the client may further record the user operation information (for example, including any one of or a combination of the following: the number of times that an advertisement in an advertising network is displayed, the number of times that an advertisement in an advertising network is clicked, a click through rate of an advertisement in an advertising network, the number of times that an advertising network is selected, the number of times that an advertising network is clicked, and a click through rate of an advertising network), where the operation information is used as a standard for determining a loss, and that the user clicks the advertisement is used as a condition to trigger updating of the policy file, so as to update the policy file. Specifically, returning to S120, if an application A delivers an advertisement for 100 times by using a distribution p¹, and clicks an advertisement of the advertising network (ADN1), it is counted that deliver is performed in ADN1 for 34 times, delivery is performed in ADN2 for 33 times, and delivery is performed in ADN3 for 33 times, so that a click through rate (CTR, click through rate) of each advertising network is obtained. For example, a click through rate CTR1 of ADN1 is equal to 1/34, a click through rate CTR2 of ADN2 is equal to 0, and a click through rate CTR3 of ADN3 is equal to 0. w²=(0.333333,0.309439,0.309439) is obtained according to a formula 2.

wᵢ^{t+1}=wᵢ^{t}·U_{β}(lᵢ^{t}) Formula 2

In addition, p²=(0.35006,0.32497,0.32497) is obtained according to the formula 1.

Therefore, when the advertisement is delivered next time, an advertising network for delivery is reselected by using a distribution p², that is, the probabilities that delivery is performed in ADN1, ADN2, and ADN3 or the probabilities that ADN1, ADN2, and ADN3 are selected are 35.006%, 32.497%, and 32.497%, respectively.

In the foregoing descriptions, the update process is described by using the CTR as a parameter, and the present invention is not limited thereto, and update may also be performed by using, for example, an effective cost per mille (eCPM, effective CPM) as a parameter; in this case, a cost per click needs to be given, an initial allocation proportion may be determined with reference to the cost per click (CPC, cost per click). ADN1 is used as example, and it is assumed that a cost per click of ADN1 is 0.5 yuan, a cost per click of ADN2 is 1 yuan, and a cost per click of ADN3 is 0.5 yuan, thus an initial allocation value of ADN1 is

$${allocation}_{ADN 1} = \frac{0.5}{0.5 + 1 + 0.5} = 0.25 .$$

In addition, correction is performed on the number of clicks. It is assumed that a correction parameter ε_{ADN1} of ADN1 is 1, thus a correction parameter of ADN2 is

$${ɛ}_{ADN 2} = {ɛ}_{ADN 1} \frac{C P {C}_{ADN 2}}{C P {C}_{ADN 1}} = 1 * \frac{1}{0.5} = 2.$$

Similarly, a correction parameter ε_{ADN3} of ADN3 is 1. That ADN2 is calculated is used as an example, a click through rate is calculated as

$$C T {R}_{ADN 2} = {ɛ}_{ADN 2} \frac{{Click}_{ADN 2}}{{Impress}_{ADN 2}} .$$

For example, if the number of times that the advertising network ADN2 is displayed is 200, and the number of times that ADN2 is clicked is 2, a corrected click through rate should be

$$2 * \frac{2}{200} = 0.02 .$$

Descriptions of a same or similar case are omitted in the following.

In the embodiment of the present invention, the first user operation information includes any one of or a combination of the following: the number of times that an advertisement in an advertising network is displayed, the number of times that an advertisement in an advertising network is clicked, the click through rate of an advertisement in an advertising network, the number of times that an advertising network is selected, the number of times that an advertising network is clicked, and the click through rate of an advertising network.

According to the advertisement delivery method in the embodiment of the present invention, a client updates information, such as a delivery proportion of an advertising network, in real time, so that a selected advertising network can meet a preference of a user in real time, thereby implementing personalized advertising network allocation.

Optionally, in the embodiment of the present invention, after the obtaining first user operation information, the method further includes:

sending a third message to the advertising platform, where the third message includes the first user operation information and the user information, so that the advertising platform updates the network information and/or the first allocation information according to the first user operation information and the user information.

Specifically, in the embodiment of the present invention, the client may feed the user operation information (for example, which may include any one of or a combination of the following: the number of times that an advertisement in an advertising network is displayed, the number of times that an advertisement in an advertising network is clicked, the click through rate of an advertisement in an advertising network, the number of times that an advertising network is selected, the number of times that an advertising network is clicked, and the click through rate of an advertising network) and the user information (for example, which may include any one of or a combination of the following: a user age, a user gender, a user location, and a user identifier) back to the advertising platform. The advertising platform may update, according to the operation information, a delivery policy (including the network information and/or the first allocation information) that corresponds to the inventory including the user information.

The procedure for updating the first allocation information by the advertising platform is as follows, that is, the advertising platform may analyze the operation information reported by the user, and generate the following Table 3 according to the inventory including the user information (using a gender and an address as an example).

TABLE 3

| | | | | | | The | | |
|---|---|---|---|---|---|---|---|---|
| | | | | | | number | The | |
| | | | | | | of | number | Click |
| Application | Advertisement | | | | Advertising | display | of | through |
| ID | space ID | User ID | Gender | Address | network | times | clicks | rate |
| 1 | adid_1 | userid_1 | Male | Nanjing | ADN1 | 200 | 2 | 0.01 |
| 1 | adid_1 | userid_1 | Male | Nanjing | ADN2 | 200 | 4 | 0.02 |
| 1 | adid_1 | userid_1 | Male | Nanjing | ADN3 | 200 | 2 | 0.01 |
| 1 | adid_1 | userid_2 | Female | Guangzhou | ADN1 | 200 | 2 | 0.01 |
| 1 | adid_1 | userid_2 | Female | Guangzhou | ADN2 | 200 | 2 | 0.01 |
| 1 | adid_1 | userid_2 | Female | Guangzhou | ADN3 | 200 | 6 | 0.03 |
| 1 | adid_1 | userid_3 | Male | Shenzhen | ADN1 | 200 | 4 | 0.02 |
| 1 | adid_1 | userid_3 | Male | Shenzhen | ADN2 | 200 | 2 | 0.01 |
| 1 | adid_1 | userid_3 | Male | Shenzhen | ADN3 | 200 | 2 | 0.01 |
| 1 | adid_1 | | Male | Nanjing | ADN1 | 200 | 6 | |
| 1 | adid_1 | | Male | Nanjing | ADN2 | 200 | 2 | |
| 1 | adid_1 | | Male | Nanjing | ADN3 | 200 | 2 | |
| 1 | adid_1 | | | | ADN1 | 1000 | 10 | |
| 1 | adid_1 | | | | ADN2 | 1000 | 10 | |
| 1 | adid_1 | | | | ADN3 | 1000 | 15 | |

In the embodiment of the present invention, when a different privacy policy is used, a manner for reporting the user information is different. It is specifically represented as that, some users do not expect that their IDs are associated with their other user information, and when this part of users report user information, they do not report user IDs. If the user IDs are reported, a click through rate is calculated; otherwise, the click through rate does not need to be calculated.

Table 4 is obtained by collecting statistics on the data in Table 3 according to the application ID, the advertisement space ID, and the region.

TABLE 4

| | | | | The number | The | Click |
|---|---|---|---|---|---|---|
| Application | Advertisement | | Advertising | of display | number of | through |
| ID | space ID | Region | network | times | clicks | rate |
| 1 | adid_1 | Nanjing | ADN1 | 400 | 8 | 0.02 |
| 1 | adid_1 | Nanjing | ADN2 | 400 | 6 | 0.015 |
| 1 | adid_1 | Nanjing | ADN3 | 400 | 4 | 0.01 |
| 1 | adid_1 | Shenzhen | ADN1 | 200 | 2 | 0.01 |
| 1 | adid_1 | Shenzhen | ADN2 | 200 | 2 | 0.01 |
| 1 | adid_1 | Shenzhen | ADN3 | 200 | 6 | 0.03 |
| 1 | adid_1 | Guangzhou | ADN1 | 200 | 4 | 0.02 |
| 1 | adid_1 | Guangzhou | ADN2 | 200 | 2 | 0.01 |
| 1 | adid_1 | Guangzhou | ADN3 | 200 | 2 | 0.01 |

Table 5 is obtained by collecting statistics on the data in Table 3 according to the application ID, the advertisement space ID, and the gender.

TABLE 5

| | | | | The number | The | Click |
|---|---|---|---|---|---|---|
| Application | Advertisement | | Advertising | of display | number of | through |
| ID | space ID | Region | network | times | clicks | rate |
| 1 | adid_1 | Male | ADN1 | 600 | 12 | 0.02 |
| 1 | adid_1 | Male | ADN2 | 600 | 8 | 0.04 |
| 1 | adid_1 | Male | ADN3 | 600 | 6 | 0.01 |
| 1 | adid_1 | Female | ADN1 | 200 | 2 | 0.01 |
| 1 | adid_1 | Female | ADN2 | 200 | 2 | 0.01 |
| 1 | adid_1 | Female | ADN3 | 200 | 6 | 0.03 |

Table 6 is obtained by collecting statistics on the data in Table 3 according to the application ID, the advertisement space ID, the gender, and the region.

TABLE 6

| | | | | | The number | The | Click |
|---|---|---|---|---|---|---|---|
| Application | Advertisement | | | Advertising | of display | number of | through |
| ID | space ID | Region | Gender | network | times | clicks | rate |
| 1 | adid_1 | Nanjing | Male | ADN1 | 400 | 8 | 0.02 |
| 1 | adid_1 | Nanjing | Male | ADN2 | 400 | 6 | 0.015 |
| 1 | adid_1 | Nanjing | Male | ADN3 | 400 | 4 | 0.01 |
| 1 | adid_1 | Guangzhou | Female | ADN1 | 200 | 2 | 0.01 |
| 1 | adid_1 | Guangzhou | Female | ADN2 | 200 | 2 | 0.01 |
| 1 | adid_1 | Guangzhou | Female | ADN3 | 200 | 6 | 0.03 |
| 1 | adid_1 | Shenzhen | Male | ADN1 | 200 | 4 | 0.02 |
| 1 | adid_1 | Shenzhen | Male | ADN2 | 200 | 2 | 0.01 |
| 1 | adid_1 | Shenzhen | Male | ADN3 | 200 | 2 | 0.01 |

In a process of generating Table 4 to Table 6, an Apriori algorithm may be used, the number of display times is used as a support degree, and the application ID, the advertisement space ID, the region, the gender, and the advertising network are used as items. The Apriori algorithm is an algorithm for mining a frequent item set in Boolean association rules. A core thereof is a recursive algorithm based on two-phase frequency set ideas.

If a certain trigger condition (for example, the number of display times or the number of clicks reaches a certain value or reaches a specified time period interval (for example, one day)) is met, the advertising platform may optimize the network information and the first allocation information according to the user information and by using the Hedge algorithm, and generate an advertising network distribution (including an advertising network vector, the parameter β, a vector wₜ, and the vector p) corresponding to the user information.

If the advertising platform can collect the user ID, the advertising platform maintains one advertising network distribution policy for each user.

It is assumed that, before optimization, allocation proportions of ADN1, ADN2, and ADN3 for various inventories are all ⅓ (as shown in Table 2). A delivery policy database 1 that corresponds to the inventory (using the application ID, the advertisement space ID, and the user ID as a condition) including the user information may be obtained by using the data in Table 3 and by using the Hedge algorithm, and for specific data, refer to Table 7.

TABLE 7

| | | | | Advertising network distribution | | | | |
|---|---|---|---|---|---|---|---|---|
| | | | | Advertising | | | | |
| Application | Advertisement | | | network | | | | |
| ID | space ID | User ID | β | vector | w | P | Display | Click |
| 1 | adid_1 | userid_1 | 0.8 | (ADN1, | (0.321, | (0.329, | (200, | (2, 4, |
| | | | | ADN2, | 0.333, | 0.342, | 200, 200) | 2 |
| | | | | ADN3) | 0.321) | 0.329) | | |
| 1 | adid_1 | userid_2 | 0.8 | (ADN1, | (0.302, | (0.322, | (200, | (2, 2, |
| | | | | ADN2, | 0.333, | 0.355, | 200, 200) | 6) |
| | | | | ADN3) | 0.302) | 0.322) | | |
| 1 | adid_1 | userid_3 | 0.8 | (ADN1, | (0.333, | (0.342, | (200, | (4, 2, |
| | | | | ADN2, | 0.321, | 0.329, | 200, 200) | 2) |
| | | | | ADN3) | 0.321) | 0.329) | | |

Similarly, a delivery policy database 2 that corresponds to the inventory (using the application ID, the advertisement space ID, and the gender as a condition) including the user information may be obtained by using the data in Table 4.

A delivery policy database that corresponds to the inventory (using the application ID, the advertisement space ID, and the region as a condition) including the user information may be obtained by using the data in Table 5.

A delivery policy database 3 that corresponds to the inventory (using the application ID, the advertisement space ID, the gender, and the region as a condition) including the user information may be obtained by using the data in Table 6.

The procedure for determining, according to the inventory, from the delivery policy database, the delivery policy that corresponds to the inventory including the user information is as follows:

if the inventory is that an application ID=1, an advertisement space ID=adid_{—}1, a user ID=userid_{—}4, and a region=Guangzhou, the advertising platform first queries the “delivery policy database 1” by using “application ID=1, advertisement space ID=adid_{—}1, user ID=userid_{—}4” as a query condition, finding that there is no suitable record; and

queries the “delivery policy database 1” by using “application ID=1, advertisement space ID=1, region=Guangzhou” as a query condition, to obtain an advertising network distribution corresponding to the inventory.

In the embodiment of the present invention, the advertising platform may further periodically update the value of β according to a formula 3:

β=g(Loss_{best}/ln N), g(z)=1/(1+\sqrt{2/z}), Formula 3

Loss_{best} represents an advertising network with a minimum loss in N times of determination. A server places the updated β in a newest policy file, and the value of β may also be designated by using a certain learning algorithm, for example, the value β value is first set to a value (such as 0.8), and a loss in a certain period is calculated; and then, the value of β is designated to another value (such as 0.9), and a loss within a certain period is calculated. β with a minimum loss within all periods is used as an optimal value. Descriptions of a same or similar case are omitted in the following.

The advertising platform generates the policy file based on the obtained advertising network distribution.

The procedure for updating the network information by the advertising platform is as follows, that is, the advertising platform may update the advertising network according to a requirement of the user. For example, the user may change the advertising network ADN3 to an advertising network ADN4 by using an operation interface, that is, the advertising networks are ADN1, ADN2, and ADN3 before the change, and the advertising networks are ADN1, ADN2, and ADN4 after the change. After the advertising network is updated, an initial value of the allocation proportion may be manually set. For example, an allocation proportion of ADN1 is set to be 0.4, an allocation proportion of ADN2 is set to be 0.4, and an allocation proportion of ADN4 is set to be 0.2. The initial value may also be automatically generated by a system, for example, allocation proportions of ADN1, ADN2, and ADN4 are all set to ⅓.

New related information about the advertising network (including information such as the delivery proportion, an advertising network interface, and an advertising network name) is recorded in a new delivery policy. In addition, the advertising platform may generate a policy file according to the new delivery policy and send the policy file to the client, so that the client performs advertisement delivery according to the new delivery policy.

In the embodiment of the present invention, the first user operation information may include any one of or a combination of the following: the number of times that an advertisement in an advertising network is displayed, the number of times that an advertisement in an advertising network is clicked, the click through rate of an advertisement in an advertising network, the number of times that an advertising network is selected, the number of times that an advertising network is clicked, and the click through rate of an advertising network.

It should be understood that, each parameter or the information listed above is only exemplary descriptions of the present invention, and the present invention is not limited thereto.

According to the advertisement delivery method in the embodiment of the present invention, an advertising platform updates information, such as a delivery proportion of an advertising network, according to user information, so that a selected advertising network can meet a preference of a user in real time, thereby implementing personalized advertising network allocation.

Case 2

Optionally, in the embodiment of the present invention, the performing advertisement delivery according to the delivery information includes:

obtaining, according to the interface file included in the delivery information and used to indicate a third delivery advertising network, at least one advertisement from the third delivery advertising network to perform delivery, where the third delivery advertising network is determined by the advertising platform from at least two candidate advertising networks according to network information and first allocation information, the network information is used to indicate the at least two candidate advertising networks, the first allocation information is used to indicate allocation proportions of advertisement display traffic in the at least two candidate advertising networks, and the network information and the first allocation information are determined by the advertising platform according to the user information.

Specifically, the advertising platform may determine the candidate advertising networks and the allocation proportion of the traffic in each candidate advertising network according to each parameter in the foregoing delivery policy. For example, in the embodiment of the present invention, according to a record in the delivery policy (Table 2), the advertising platform first determines the initial weight w¹=(0.333, 0.333, 0.333) in the Hedge algorithm, determines the adjustable parameter β=0.8 and U_{β}(lᵢ^{t})=0.8^{l}^{ᵢ}^{^{t}} in the Hedge algorithm. Then, according to a formula 1, it is determined that delivery proportions of ADN1, ADN2, and ADN3 are p¹=(0.333, 0.333, 0.333), representing that traffic allocation of ADN1, ADN2, and ADN3 each accounts for ⅓, that is, probabilities that delivery is performed in ADN1, ADN2, and ADN3 or probabilities that ADN1, ADN2, and ADN3 are selected are each 33.3%. Further, one advertising network for delivering an advertisement is selected from the candidate advertising networks according to the allocation proportions, and an interface file of the advertising network is sent to the user, and in S120, the client obtains the interface file from the received second message.

In S130, the client directly obtains, from an advertising network indicated by the interface file, an advertisement to perform delivery.

According to the advertisement delivery method in the embodiment of the present invention, an advertising network is selected with reference to user information, so that a selected advertising network can meet a preference of a user, thereby implementing personalized advertising network allocation.

Optionally, the performing advertisement delivery according to the delivery information further includes:

obtaining second user operation information; and

sending a fourth message to the advertising platform, where the fourth message includes the second user operation information and the user information, so that the advertising platform updates the network information and/or the first allocation information according to the second user operation information and the user information.

In the embodiment of the present invention, the client may feed related information about the advertising network corresponding to the interface file back to the advertising platform. Because the client obtains an advertisement only from one advertising network corresponding to the interface file, a parameter fed back to the advertising platform only includes related information about the one advertising network; besides that, the procedure for updating the delivery policy by the advertising platform is similar to that in the case 1, and is not described herein again to avoid repetition.

According to the advertisement delivery method in the embodiment of the present invention, an advertising platform updates information, such as a delivery proportion of an advertising network, according to user information, so that a selected advertising network can meet a preference of a user in real time, thereby implementing personalized advertising network allocation.

In the embodiment of the present invention, the second user operation information includes any one of or a combination of the following: information about an advertising network to which an advertisement belongs, the number of times that an advertisement is displayed, the number of times that an advertisement is clicked, and a click through rate of an advertisement.

It should be understood that, each parameter or the information listed above is only exemplary descriptions of the present invention, and the present invention is not limited thereto, for example, each parameter or the information may further include the information about an advertising network to which an advertisement belongs; however, because the advertising network from which the user obtains an advertisement is selected by the advertising platform, the advertising platform may also record the advertising network based on a correspondence between the user information and the advertising network selected for the user.

Case 3

Optionally, in the embodiment of the present invention,

the performing advertisement delivery according to the delivery information includes:

obtaining, according to advertisement information and second allocation information that are included in the delivery information, at least one advertisement from at least two advertisements to perform delivery. Where the advertisement information is used to indicate the at least two advertisements, the second allocation information is used to indicate allocation proportions of advertisement display traffic in the at least two advertisements. The advertisement information and the second allocation information are determined by the advertising platform according to network information and first allocation information. The network information is used to indicate at least two candidate advertising networks, and the first allocation information is used to indicate allocation proportions of the advertisement display traffic in the at least two candidate advertising networks. The network information and the first allocation information are determined by the advertising platform according to the user information.

Specifically, the advertising platform may determine each candidate advertising network and the allocation proportion of the traffic in each candidate advertising network according to each parameter in the foregoing delivery policy. For example, in the embodiment of the present invention, according to a record in the delivery policy (Table 2), the advertising platform first determines an initial weight w¹=(0.333, 0.333, 0.333) in the Hedge algorithm, determines the adjustable parameter β=0.8 and U_{β}(lᵢ^{t})=0.8^{l}^{ᵢ}^{^{t}} in the Hedge algorithm. Then, according to a formula 1, it is determined that delivery proportions of ADN1, ADN2, and ADN3 are p¹=(0.333, 0.333, 0.333), representing that traffic allocation of ADN1, ADN2, and ADN3 each accounts for ⅓, that is, probabilities that delivery is performed in ADN1, ADN2, and ADN3 or probabilities that ADN1, ADN2, and ADN3 are selected are each 33.3%. Further, at least two advertisements are obtained from the candidate advertising networks according to the allocation proportions, for example, one advertisement AD1 is selected from ADN1, one advertisement AD2 is selected from ADN2, and two advertisements AD3 and AD4 are selected from ADN3; in this case, because the probabilities that delivery is performed in ADN1, ADN2, and ADN3 or the probabilities that ADN1, ADN2, and ADN3 are selected are each 33.3%, probabilities that AD1 and AD2 are selected are each 33%, while probabilities that AD3 and AD4 are selected are each 16.5%, the advertising platform sends advertisement information used to indicate the foregoing candidate advertisements (AD1, AD2, AD3, and AD4) and traffic allocation proportion information to the client. In S120, the client obtains the advertisement information and the traffic allocation proportion information from the received second message.

In S130, the client selects, according to an allocation proportion indicated by the traffic allocation proportion information, from the candidate advertisements (AD1, AD2, AD3, and AD4), an advertisement for delivery, to perform delivery.

According to the advertisement delivery method in the embodiment of the present invention, an advertisement is selected with reference to user information, so that the selected advertisement can meet a preference of a user, thereby implementing personalized advertising network allocation, and a client does not need to establish a connection to an advertising network, thereby reducing an impact on user performance.

Optionally, the performing advertisement delivery according to the delivery information further includes:

obtaining second user operation information;

sending a fourth message to the advertising platform, where the fourth message includes the second user operation information and the user information, so that the advertising platform updates the network information and/or the first allocation information according to the second user operation information and the user information.

In the embodiment of the present invention, because the user does not select an advertising network, a parameter fed back to the advertising platform only includes related information about the advertisement; besides that, the procedure for updating the delivery policy by the advertising platform is similar to that in the case 1, and is not described herein again to avoid repetition.

According to the advertisement delivery method in the embodiment of the present invention, an advertising platform updates information, such as a delivery proportion of an advertising network, according to user information, so that a selected advertising network can meet a preference of a user in real time, thereby implementing personalized advertising network allocation.

In the embodiment of the present invention, the second user operation information includes any one of or a combination of the following: the number of times that an advertisement is displayed, the number of times that an advertisement is clicked, a click through rate of an advertisement, and information about an advertising network to which an advertisement belongs.

It should be understood that, each parameter or the information listed above is only exemplary descriptions of the present invention, and the present invention is not limited thereto.

Returning to S130, optionally, in the embodiment of the present invention, after the performing advertisement delivery, the method further includes:

storing, in an advertisement database, the advertisement that is obtained according to the delivery information. It should be noted that, the advertisement database may be stored in the client, or may be stored in another entity, and a specific location of the advertisement database is not limited in the embodiment of the present invention.

After the storing, in an advertisement database, the advertisement that is obtained according to the delivery information, the method further includes:

obtaining at least one advertisement from the advertisement database to perform delivery.

Specifically, after obtaining the advertisement, the client may store the advertisement in a local advertisement database. According to the advertisement delivery method in the embodiment of the present invention, when an advertisement needs to be delivered next time (for example, an application is started), the client may directly select the advertisement from the local advertisement database to perform delivery, thereby improving the efficiency of advertisement delivery and reducing an impact on user performance.

In the embodiment of the present invention, the user information may include any one of or a combination of the following: a user age, a user gender, a user location, and a user identifier.

It should be understood that, each parameter or the information listed above is only exemplary descriptions of the present invention, and the present invention is not limited thereto.

FIG. 2 shows a schematic flowchart of an advertisement delivery method 200 according to an embodiment of the present invention, which is described from the perspective of an advertising platform. As shown in FIG. 2, the method 200 includes:

S210: Receive a first message sent by a client and including user information.

S220: Determine network information and first allocation information according to the user information, where the network information is used to indicate at least two candidate advertising networks, and the first allocation information is used to indicate allocation proportions of advertisement display traffic in the at least two candidate advertising networks; and determine delivery information according to the network information and the first allocation information.

S230: Send a second message including the delivery information to the client, so that the client performs advertisement delivery according to the delivery information.

Specifically, for example, when a user starts an application or browses a content website by using a browser, the client may send the first message including the user information (for example, a user ID, a user age, a user gender, and a user location) to the advertising platform, and in S210, the advertising platform receives the first message.

In S220, after receiving the first message, the advertising platform may generate an inventory according to the user information (for example, a user ID, a user age, a user gender, and a user location) and advertisement space information (for example, an application ID, an advertisement space ID, an advertisement space size, and an advertisement space category), so that the advertising platform can determine, according to the inventory, from a delivery policy database, a delivery policy that corresponds to the inventory including the user information, and generate a policy file.

Specifically, the advertising platform may maintain one user information database. User information in the user information database may be provided by a developer of an application of the client, may also be reported by a user, and may further be provided by a third party server. Therefore, the advertising platform may further query, according to a specified condition (such as a user ID), the user information stored in the user information database. Therefore, when the user information included in the first message is the user ID, and if the user ID is stored in the user information database, the advertising platform may determine other related information about the user according to the following Table 1. Therefore, the advertising platform may combine the user information (for example, a user ID, a user age, a user gender, and a user location) with the advertisement space information (for example, the application ID, the advertisement space ID, the advertisement space size, and the advertisement space category) to generate the inventory.

In addition, the advertising platform may further determine a delivery policy meeting a preference of the user, according to the inventory (including the user information, for example, the user ID), from a delivery policy database (as shown in Table 2) maintained by the advertising platform and used to indicate a correspondence between the inventory (including the user information, for example, a combination of an application ID, the advertisement space ID, and the user ID) and the delivery policy. And the advertising platform generates a policy file, where the inventory and the advertising network distribution may be stored in a manner of a multi-dimensional database (for example, fastbit) for query.

For example, as shown in Table 2, it is determined that the candidate advertising networks are ADN1, ADN2, and ADN3, and it is determined that a vector p is an allocation proportion of the advertising network.

In the embodiment of the present invention, the advertising platform may directly send the policy file to the client (case 4); the advertising platform may also select by itself one advertising network according to the delivery policy and according to candidate advertising networks and a traffic allocation proportion that are recorded in the delivery policy, generate an interface file of the advertising network, and send the interface file to the client (case 5); and the advertising platform may further select one or more advertising networks according to the policy file, and obtain at least two advertisements from the selected advertising network, and notify the client of an allocation proportion of the advertisement display traffic in each advertisement, so that the client delivers an advertisement according to the allocation proportion (case 6). These three cases are described respectively in the following.

Case 4

In S230, optionally, in the embodiment of the present invention, the advertising platform may directly send the policy file to the client. And the client obtains the advertisement according to the policy file and according to the candidate advertising networks and the allocation proportion of the advertisement display traffic in each candidate advertising network, where the candidate advertising networks and the allocation proportion are recorded in the policy file. Therefore, the determining delivery information according to the network information and the first allocation information includes:

determining, according to the network information and the first allocation information, delivery information including the network information and the first allocation information.

Specifically, the advertising platform may send the policy file to the client, where the policy file records the network information used to indicate the at least two candidate advertising networks (for example, information that indicates three advertising networks: ADN1, ADN2, and ADN3, in the policy file), and the first allocation information used to indicate the allocation proportion of the advertisement display traffic (briefly referred to as traffic in the following) in each advertising network (for example, 0.333, 0.333, and 0.333 in the policy file represent initial weights used to calculate allocation proportions of the traffic in the three advertising networks: ADN1, ADN2, and ADN3).

The client may determine the candidate advertising networks and the allocation proportion of the traffic in each candidate advertising network according to parameters in the policy file, and specifically, the client may determine an initial weight w¹=(0.333, 0.333, 0.333) in a Hedge algorithm, and determine an adjustable parameter β=0.8 and U_{β}(lᵢ^{t})=0.8^{l}^{ᵢ}^{^{t}} in the Hedge algorithm. According to a formula 1, it is determined that delivery proportions of ADN1, ADN2, and ADN3 are p¹=(0.333, 0.333, 0.333) (representing that traffic allocation of ADN1, ADN2, and ADN3 each accounts for ⅓, that is, probabilities that delivery is performed ADN1, ADN2, and ADN3 or probabilities that ADN1, ADN2, and ADN3 are selected are each 33.3%), and the client selects, according to the allocation proportions, from the candidate advertising networks (ADN1, ADN2, and ADN3), an advertising network for delivering an advertisement, to perform advertisement delivery.

According to the advertisement delivery method in the embodiment of the present invention, an advertising network is selected with reference to user information, so that a selected advertising network can meet a preference of a user, thereby implementing personalized advertising network allocation.

Optionally, in the present invention, after the sending a second message including the delivery information to the client, the method further includes:

receiving a third message that is sent by the client and includes first user operation information and the user information; and

updating the network information and/or the first allocation information according to the first user operation information and the user information.

Specifically, in the embodiment of the present invention, the client may feed the operation information (for example, which includes any one of or a combination of the following: the number of times that an advertisement in an advertising network is displayed, the number of times that an advertisement in an advertising network is clicked, a click through rate of an advertisement in an advertising network, the number of times that an advertising network is selected, the number of times that an advertising network is clicked, and a click through rate of an advertising network) and the user information (for example, which includes any one of or a combination of the following: a user age, a user gender, a user location, and a user identifier) back to the advertising platform. The advertising platform may update, according to the operation information, the delivery policy (including the network information and/or the first allocation information) that corresponds to the inventory including the user information. For example, if an application A delivers an advertisement for 100 times by using a distribution p¹, and clicks an advertisement of the advertising network (ADN1), it is counted that delivery is performed in ADN1 for 34 times, delivery is performed in ADN2 for 33 times, and delivery is performed in ADN3 for 33 times, so that a click through rate (CTR, click through rate) of each advertising network is obtained. For example, a click through rate CTR1 of ADN1 is equal to 1/34, a click through rate CTR2 of ADN2 is equal to 0, and a click through rate CTR3 of ADN1 is equal to 0.

In the foregoing descriptions, the update process is described by using the CTR as a parameter, and the present invention is not limited thereto, and update may also be performed by using, for example, an effective cost per mille (eCPM, effective CPM) as a parameter; in this case, a cost per click needs to be given, an initial allocation proportion may be determined with reference to the cost per click (CPC, cost per click). ADN1 is used as example, and it is assumed that a cost per click of ADN1 is 0.5 yuan, a cost per click of ADN2 is 1 yuan, and a cost per click of ADN3 is 0.5 yuan, thus an initial allocation value of ADN1 is

$${allocation}_{ADN 1} = \frac{0.5}{0.5 + 1 + 0.5} = 0.25 .$$

In addition, correction is performed on the number of clicks, it is assumed that a correction parameter ε_{ADN1} of ADN1 is 1, thus a correction parameter of ADN2 is

$${ɛ}_{AND 2} = {ɛ}_{AND 1} \frac{C P {C}_{ADN 2}}{C P {C}_{ADN 1}} = 1 * \frac{1}{0.5} = 2.$$

Similarly, a correction parameter ε_{ADN3} of ADN3 is 1. That ADN2 is calculated is used as an example, a click through rate is calculated as

$$C T {R}_{ADN 2} = {ɛ}_{ADN 2} \frac{{Click}_{ADN 2}}{{Impress}_{ADN 2}} .$$

For example, if the number of times that the advertising network ADN2 is displayed is 200, and the number of times that ADN2 is clicked is 2, a corrected click through rate should be

$$2 * \frac{2}{200} = 0.02 .$$

Descriptions of a same or similar case are omitted in the following.

The procedure for updating the first allocation information by the advertising platform is as follows, that is, the advertising platform may analyze the operation information reported by the client, and generate Table 3 according to the inventory including the user information (using a gender and an address as an example).

In the embodiment of the present invention, when a different privacy policy is used, a manner for reporting the user information is different. It is specifically represented as that, some users do not expect that their IDs are associated with their other user information, and when this part of users report user information, they may not report user IDs. If the user IDs are reported, a click through rate is calculated; otherwise, the click through rate does not need to be calculated.

Table 4 is obtained by collecting statistics on data in Table 3 according to an application ID, an advertisement space ID, and a region.

Table 5 is obtained by collecting statistics on the data in Table 3 according to the application ID, the advertisement space ID, and a gender.

Table 6 is obtained by collecting statistics on the data in Table 3 according to the application ID, the advertisement space ID, the gender, and the region.

In a process of generating Table 4 to Table 6, an Apriori algorithm may be used, the number of display times is used as a support degree, and the application ID, the advertisement space ID, the region, the gender, and the advertising network are used as items.

If a certain trigger condition (for example, the number of display times or the number of clicks reaches a certain value or reaches a specified time period interval (for example, one day)) is met, the advertising platform may optimize the network information and the first allocation information according to the inventory and by using the Hedge algorithm, and generate an advertising network distribution (including an advertising network vector, the parameter β, a vector wᵢ, and the vector p) corresponding to the user information.

If the advertising platform can collect the user ID, the advertising platform maintains one advertising network distribution policy for each user.

It is assumed that, before optimization, allocation proportions of ADN1, ADN2, and ADN3 for various inventories are all ⅓ (as shown in Table 2). A delivery policy database 1 that corresponds to the inventory (using the application ID, the advertisement space ID, and the user ID as a condition) including the user information may be obtained by using the data in Table 3 and by using the Hedge algorithm, and for specific data, refer to Table 7.

Similarly, a delivery policy database 2 that corresponds to the inventory (using the application ID, the advertisement space ID, and the gender as a condition) including the user information may be obtained by using data in Table 4.

A delivery policy database that corresponds to the inventory (using the application ID, the advertisement space ID, and the region as a condition) including the user information may be obtained by using data in Table 5.

A delivery policy database 3 that corresponds to the inventory (using the application ID, the advertisement space ID, the gender, and the region as a condition) including the user information may be obtained by using data in Table 6.

The procedure for determining, according to the inventory, from the delivery policy database, the delivery policy that corresponds to the inventory including the user information is as follows:

if the inventory is that an application ID=1, an advertisement space ID=adid_{—}1, a user ID=userid_{—}4, and a region=Guangzhou, the advertising platform first queries the “delivery policy database 1” by using “application ID=1, advertisement space ID=adid_{—}1, user ID=userid_{—}4” as a query condition, finding that there is no suitable record; and

queries the “delivery policy database 1” by using “application ID=1, advertisement space ID=1, region=Guangzhou” as a query condition, to obtain an advertising network distribution corresponding to the inventory.

In the embodiment of the present invention, the advertising platform may further periodically update a value of β according to a formula 3, and the value of β may also be designated by using a certain learning algorithm, for example, the value of β is first set to a value (such as 0.8), and a loss in a certain period is calculated; and then, the value of β is designated to another value (such as 0.9), and a loss within a certain period is calculated. β with a minimum loss within all periods is used as an optimal value.

The advertising platform generates the policy file based on the obtained advertising network distribution.

The procedure for updating the network information by the advertising platform is as follows, that is, the advertising platform may update the advertising network according to a requirement of the user, and specifically, the user may change. For example, the advertising network ADN3 to an advertising network ADN4 by using an operation interface, that is, the advertising networks are ADN1, ADN2, and ADN3 before the change, and the advertising networks are ADN1, ADN2, and ADN4 after the change. After the advertising network is updated, an initial value of the allocation proportion may be manually set. For example, an allocation proportion of ADN1 is set to be 0.4, an allocation proportion of ADN2 is set to be 0.4, and an allocation proportion of ADN4 is set to be 0.2. The initial value may also be automatically generated by a system, for example, ADN1, ADN2, and ADN4 are all set tot/3.

New related information about the advertising network (including information such as the delivery proportion, an advertising network interface, and an advertising network name) is recorded in a new delivery policy. In addition, the advertising platform may generate a policy file according to the new delivery policy and send the policy file to the client, so that the client performs advertisement delivery according to the new delivery policy.

In the embodiment of the present invention, the first user operation information may include any one of or a combination of the following: the number of times that an advertisement in an advertising network is displayed, the number of times that an advertisement in an advertising network is clicked, the click through rate of an advertisement in an advertising network, the number of times that an advertising network is selected, the number of times that an advertising network is clicked, and the click through rate of an advertising network.

It should be understood that, each parameter or the information listed above is only exemplary descriptions of the present invention, and the present invention is not limited thereto.

According to the advertisement delivery method in the embodiment of the present invention, an advertising platform updates information, such as a delivery proportion of an advertising network, according to user information, so that a selected advertising network can meet a preference of a user in real time, thereby implementing personalized advertising network allocation.

Case 5

Returning to S230, optionally, in the embodiment of the present invention, the advertising platform may also select by itself one advertising network according to the delivery policy and according to each candidate advertising network and the allocation proportion of traffic in each candidate advertising network, where the each candidate advertising network and the allocation proportion are recorded in the delivery policy. The advertising platform generates an interface file of the advertising network, and sends the interface file to the client. The client may directly obtain, according to the interface file, an advertisement from the advertising network corresponding to the interface file. Therefore, the determining delivery information according to the network information and the first allocation information includes:

determining a third delivery advertising network from the at least two candidate advertising networks according to the network information and the first allocation information; and

determining delivery information including an interface file, where the interface file is used to indicate the third delivery advertising network.

Specifically, the advertising platform may determine each candidate advertising network and the allocation proportion of the traffic in each candidate advertising network according to each parameter in the foregoing delivery policy. For example, in the embodiment of the present invention, according to a record in the delivery policy (Table 2), the advertising platform first determines an initial weight w¹=(0.333, 0.333, 0.333) in a Hedge algorithm, determines an adjustable parameter β=0.8 and U_{β}(lᵢ^{t})=0.8^{l}^{ᵢ}^{^{t}} in the Hedge algorithm. Then, according to a formula 1, it is determined that delivery proportions of ADN1, ADN2, and ADN3 are p¹=(0.333, 0.333, 0.333), representing that traffic allocation of ADN1, ADN2, and ADN3 each accounts for ⅓, that is, probabilities that delivery is performed in ADN1, ADN2, and ADN3 or probabilities that ADN1, ADN2, and ADN3 are selected are each 33.3%. Further, one advertising network for delivering an advertisement is selected from the candidate advertising networks according to the allocation proportions, and an interface file of the advertising network is sent to the client.

According to the advertisement delivery method in the embodiment of the present invention, an advertising network is selected with reference to user information, so that a selected advertising network can meet a preference of a user, thereby implementing personalized advertising network allocation.

Optionally, in the present invention, after the sending a second message including the delivery information to the client, the method further includes:

receiving a fourth message that is sent by the client and includes second user operation information and the user information; and

updating the network information and/or the first allocation information according to the second user operation information and the user information.

In the embodiment of the present invention, the client may feed related information about the advertising network corresponding to the interface file back to the advertising platform. Because the client obtains an advertisement only from one advertising network corresponding to the interface file, a parameter fed back to the advertising platform only includes related information about the one advertising network; besides that, the procedure for updating the delivery policy by the advertising platform is similar to that in the case 4, and is not described herein again to avoid repetition.

In the embodiment of the present invention, the second user operation information includes any one of or a combination of the following: the number of times that an advertisement is displayed, the number of times that an advertisement is clicked, and a click through rate of an advertisement.

It should be understood that, each parameter or the information listed above is only exemplary descriptions of the present invention, and the present invention is not limited thereto, for example, each parameter or the information may further include information about an advertising network to which an advertisement belongs; however, because the advertising network from which the client obtains the advertisement is selected by the advertising platform, the advertising platform may also record the advertising network based on a correspondence between the user information and the advertising network selected for the user.

According to the advertisement delivery method in the embodiment of the present invention, an advertising platform updates information, such as a delivery proportion of an advertising network, according to user information, so that a selected advertising network can meet a preference of a user in real time, thereby implementing personalized advertising network allocation.

Case 6

Returning to S230, optionally, in the embodiment of the present invention, the determining delivery information according to the network information and the first allocation information includes:

determining a fourth delivery advertising network from the at least two candidate advertising networks according to the network information and the first allocation information, and obtaining at least two advertisements from the fourth delivery advertising network;

determining allocation proportions of advertisement display traffic in the at least two advertisements according to the first allocation information; and

determining delivery information including advertisement information and second allocation information, where the advertisement information is used to indicate the at least two advertisements, and the second allocation information is used to indicate the allocation proportions of the advertisement display traffic in the at least two advertisements.

Specifically, the advertising platform may determine the candidate advertising networks and the allocation proportion of the traffic in each advertising network according to each parameter in the foregoing delivery policy. For example, in the embodiment of the present invention, according to a record in the delivery policy (Table 2), the advertising platform first determines an initial weight w¹=(0.333, 0.333, 0.333) in a Hedge algorithm, determines an adjustable parameter β=0.8 and U_{β}(lᵢ^{t})=0.8^{l}^{ᵢ}^{^{t}} in the Hedge algorithm. Then, according to a formula 1, it is determined that delivery proportions of ADN1, ADN2, and ADN3 are p¹=(0.333, 0.333, 0.333), representing that traffic allocation of ADN1, ADN2, and ADN3 each accounts for ⅓, that is, probabilities that delivery is performed in ADN1, ADN2, and ADN3 or probabilities that ADN1, ADN2, and ADN3 are selected are each 33.3%. Further, at least two advertisements are obtained from the candidate advertising networks according to the allocation proportions, for example, one advertisement AD1 is selected from ADN1, one advertisement AD2 is selected from ADN2, and two advertisements AD3 and AD4 are selected from ADN3; in this case, because the probabilities that delivery is performed in ADN1, ADN2, and ADN3 or the probabilities that ADN1, ADN2, and ADN3 are selected are each 33.3%, probabilities that AD1 and AD2 are selected are each 33%, while probabilities that AD3 and AD4 are selected are each 16.5%, and the advertising platform sends advertisement information used to indicate the foregoing candidate advertisements (AD1, AD2, AD3, and AD4) and the traffic allocation proportion to the client.

According to the advertisement delivery method in the embodiment of the present invention, an advertisement is selected with reference to user information, so that the selected advertisement can meet a preference of a user, thereby implementing personalized advertising network allocation, and a client does not need to establish a connection to an advertising network, thereby reducing an impact on user performance.

Optionally, in the present invention, after the sending a second message including the delivery information to the client, the method further includes:

receiving a fourth message that is sent by the client and includes second user operation information and the user information; and

updating the network information and/or the first allocation information according to the second user operation information and the user information.

In the embodiment of the present invention, because the user obtains an advertisement only from a specific advertising network, a parameter fed back to the advertising platform only includes related information about the one advertising network; besides that, the procedure for updating the delivery policy by the advertising platform is similar to that in the case 4, and is not described herein again to avoid repetition.

In the embodiment of the present invention, the second user operation information includes any one of or a combination of the following: information about an advertising network to which an advertisement belongs, the number of times that an advertisement is displayed, the number of times that an advertisement is clicked, and a click through rate of an advertisement.

It should be understood that, each parameter or the information listed above is only exemplary descriptions of the present invention, and the present invention is not limited thereto.

According to the advertisement delivery method in the embodiment of the present invention, an advertising platform updates information, such as a delivery proportion of an advertising network, according to user information, so that a selected advertising network can meet a preference of a user in real time, thereby implementing personalized advertising network allocation.

In the embodiment of the present invention, the user information may include any one of or a combination of the following: a user age, a user gender, a user location, and a user identifier.

It should be understood that, each parameter or the information listed above is only exemplary descriptions of the present invention, and the present invention is not limited thereto.

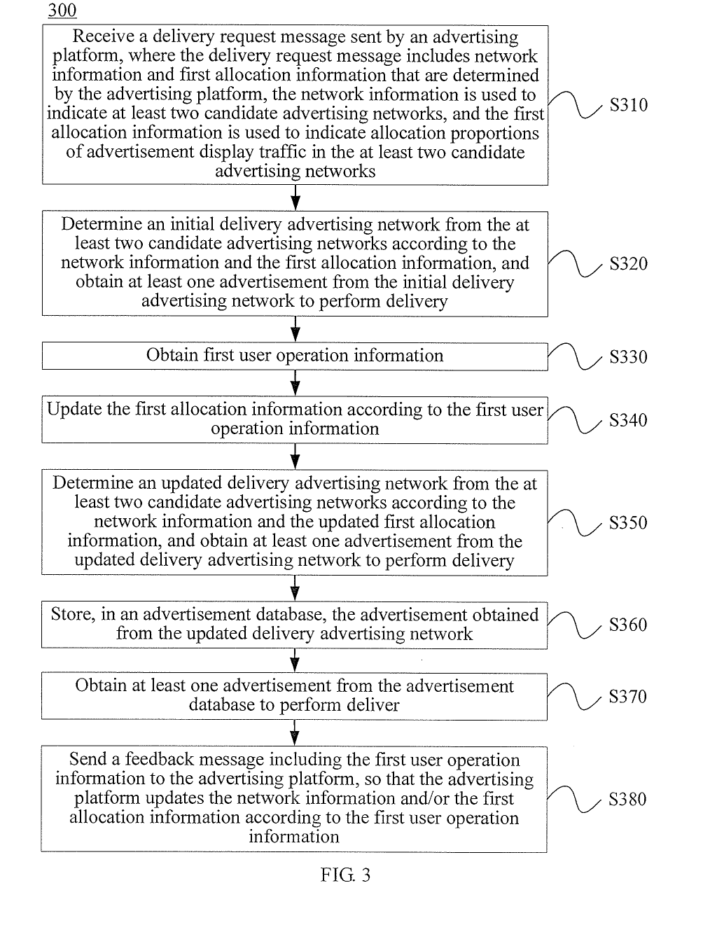

FIG. 3 shows a schematic flowchart of an advertisement delivery method 300 according to an embodiment of the present invention, which is described from the perspective of a client. As shown in FIG. 3, the method 300 includes:

S310: Receive a delivery request message sent by an advertising platform, where the delivery request message includes network information and first allocation information, and the network information and first allocation information are determined by the advertising platform. The network information is used to indicate at least two candidate advertising networks, and the first allocation information is used to indicate allocation proportions of advertisement display traffic in the at least two candidate advertising networks.

S320: Determine an initial delivery advertising network from the at least two candidate advertising networks according to the network information and the first allocation information, and obtain at least one advertisement from the initial delivery advertising network to perform delivery.

S330: Obtain first user operation information.

S340: Update the first allocation information according to the first user operation information.

S350: Determine an updated delivery advertising network from the at least two candidate advertising networks according to the network information and the updated first allocation information, and obtain at least one advertisement from the updated delivery advertising network to perform delivery.

In the embodiment of the present invention, the client may not report user information to the advertising platform, and the advertising platform may not determine the candidate advertising networks or a traffic allocation proportion according to the user information.

Specifically, in S310, the client receives a policy file sent by the advertising platform and used to indicate a delivery policy. In one aspect, for example, when a user starts an application or browses a content website by using a browser, the client may send an delivery request message to the advertising platform, so that the advertising platform sends the policy file according to the request message; in another aspect, the advertising platform my also actively send the policy file to the client.

The advertising platform may determine by itself an advertising network for delivering an advertisement and an allocation proportion of the traffic in each advertising network, record the information in the policy file, and send the policy file to the client.

In S320, the client may determine each candidate advertising network and the allocation proportion of the traffic in each candidate advertising network according to parameters in the policy file. For example, in the embodiment of the present invention, the client may determine, according to the foregoing policy file 1, that the candidate advertising networks are ADN1, ADN2, and ADN3, and determine an initial weight w¹=(0.333, 0.333, 0.333) for traffic allocation, and determine an adjustable parameter β=0.8 and U_{β}(lᵢ^{t})=0.8^{l}^{ᵢ}^{^{t}} in a Hedge algorithm. In addition, according to a formula 1, it is determined that delivery proportions of ADN1, ADN2, and ADN3 are p¹=(0.333, 0.333, 0.333), representing that traffic allocation of ADN1, ADN2, and ADN3 each accounts for ⅓, that is, probabilities that delivery is performed in ADN1, ADN2, and ADN3 or probabilities that ADN1, ADN2, and ADN3 are selected are each 33.3%.

In S330, the client selects, according to the allocation proportions, from the candidate advertising networks, an advertising network for delivering an advertisement, to perform advertisement delivery.

In S340, after delivering the advertisement, the client may record the user operation information (for example, a click through rate of the advertisement in the advertising network), where the operation information is used as a standard for determining a loss, and that the user clicks the advertisement is used as a condition to trigger updating of the policy file, so as to update the policy file. Specifically, if an application A delivers an advertisement for 100 times by using a distribution p¹, and clicks an advertisement of the advertising network (ADN1), it is counted that delivery is performed in ADN1 for 34 times, delivery is performed in ADN2 for 33 times, and delivery is performed in ADN3 for 33 times, so that a click through rate (CTR, click through rate) of each advertising network is obtained. For example, a click through rate CTR1 of ADN1 is equal to 1/34, a click through rate CTR2 of ADN2 is equal to 0, and a click through rate CTR3 of ADN1 is equal to 0. w²=(0.333333, 0.309439, 0.309439) is obtained according to a formula 2. p²=(0.35006, 0.32497, 0.32497) is obtained according to the formula 1.

In S350, when the advertisement is delivered next time, the client selects an advertisement network for delivery by using a distribution p², that is, the probabilities that delivery is performed in ADN1, ADN2, and ADN3 or the probabilities that ADN1, ADN2, and ADN3 are selected are 35.006%, 32.497%, and 32.497%, respectively.

In the foregoing descriptions, the update process is described by using the CTR as a parameter, and the present invention is not limited thereto, and update may also be performed by using, for example, an effective cost per mille (eCPM, effective CPM) as a parameter; in this case, a cost per click needs to be given, an initial allocation proportion may be determined with reference to the cost per click (CPC, cost per click). ADN1 is used as example, and it is assumed that a cost per click of ADN1 is 0.5 yuan, a cost per click of ADN2 is 1 yuan, and a cost per click of ADN3 is 0.5 yuan, thus an initial allocation value of ADN1 is

$${allocation}_{ADN 1} = \frac{0.5}{0.5 + 1 + 0.5} = 0.25 .$$

In addition, correction is performed on the number of clicks. It is assumed that a correction parameter ε_{ADN1} of ADN1 is 1, thus a correction parameter of ADN2 is

$${ɛ}_{AND 2} = {ɛ}_{AND 1} \frac{C P {C}_{ADN 2}}{C P {C}_{ADN 1}} = 1 * \frac{1}{0.5} = 2.$$

Similarly, a correction parameter ε_{ADN3} of ADN3 is 1. That ADN2 is calculated is used as an example, a click through rate is calculated as

$$C T {R}_{ADN 2} = {ɛ}_{ADN 2} \frac{{Click}_{ADN 2}}{{Impress}_{ADN 2}} .$$

For example, if the number of times that the advertising network ADN2 is displayed is 200, and the number of times that ADN2 is clicked is 2, a corrected click through rate should be

$$2 * \frac{2}{200} = 0.02 .$$

Descriptions of a same or similar case are omitted in the following.

According to the advertisement delivery method in the embodiment of the present invention, a client updates information, such as a delivery proportion of an advertising network, in real time, and the advertising network can be selected with reference to user information, so that the selected advertising network meets a preference of a user in real time, thereby implementing personalized advertising network allocation.

Optionally, in this embodiment, the method 300 further includes:

S360: Store, in an advertisement database, the advertisement obtained from the updated delivery advertising network.

It should be noted that, the advertisement database may be stored in the client, or may be stored in another entity, and a specific location of the advertisement database is not limited in the embodiment of the present invention.

S370: Obtain at least one advertisement from the advertisement database to perform delivery.

Specifically, after obtaining the advertisement, the client may store the advertisement in a local advertisement database. According to the advertisement delivery method in the embodiment of the present invention, when the advertisement needs to be delivered next time (for example, an application is started), the client may directly select the advertisement from the local advertisement database to perform delivery, thereby improving the efficiency of advertisement delivery and reducing an impact on user performance.

Optionally, in the embodiment of the present invention, the advertising platform sends a second message including the user operation information, so that the advertising platform updates the network information and/or the first allocation information according to the user operation information.

Specifically, in the embodiment of the present invention, the method 300 may further include:

S380: Send a feedback message including the first user operation information to the advertising platform, so that the advertising platform updates the network information and/or the first allocation information according to the first user operation information.

It should be noted that, step S380 can be performed after the first user operation information is obtained.

Specifically, the advertising platform may collect statistics, according to an application ID, and an advertisement space ID, on the information reported by the client, to obtain data in Table 8.

TABLE 8

| Appli- | | Adver- | The number | The | Click |
|---|---|---|---|---|---|
| cation | Advertisement | tising | of display | number of | through |
| ID | space ID | network | times | clicks | rate |
| 1 | adid_1 | ADN1 | 1800 | 24 | 0.0133 |
| 1 | adid_1 | ADN2 | 1800 | 20 | 0.0111 |
| 1 | adid_1 | ADN3 | 1800 | 27 | 0.015 |

In a process of generating Table 8, an Apriori algorithm may be used, the number of display times is used as a support degree, and the application ID and the advertisement space ID are used as items.

If a certain trigger condition (for example, the number of display times or the number of clicks reaches a certain value or reaches a specified time period interval (for example, one day)) is met, the advertising platform may optimize the network information and the first allocation information by using the Hedge algorithm, and generate an advertising network distribution (including an advertising network vector, the parameter β, a vector wᵢ, and the vector p).

It is assumed that, before optimization, allocation proportions of ADN1/ADN2/ADN3 for various inventories are all ⅓ (as shown in Table 1). A delivery policy database 1 corresponding to a condition vector (using the application ID and the advertisement space ID as a condition) may be obtained by using the data in Table 8 and by using the Hedge algorithm, and for specific data, refer to Table 9.

TABLE 9

| | | | Advertising network distribution | | | | |
|---|---|---|---|---|---|---|---|
| | | | Advertising | | | | |
| Application | Advertisement | | network | | | | |
| ID | space ID | β | vector | w | P | Display | Click |
| 1 | adid_1 | 0.8 | (ADN1, | (0.321, | (0.329, | (200, | (2, 4, |
| | | | ADN2, | 0.333, | 0.342, | 200, 200) | 2 |
| | | | ADN3) | 0.321) | 0.329) | | |
| 1 | adid_1 | 0.8 | (ADN1, | (0.302, | (0.322, | (200, | (2, 2, |
| | | | ADN2, | 0.333, | 0.355, | 200, 200) | 6) |
| | | | ADN3) | 0.302) | 0.322) | | |
| 1 | adid_1 | 0.8 | (ADN1, | (0.333, | (0.342, | (200, | (4, 2, |
| | | | ADN2, | 0.321, | 0.329, | 200, 200) | 2) |
| | | | ADN3) | 0.321) | 0.329) | | |

In the embodiment of the present invention, the advertising platform may further periodically update the value of β according to a formula 3, and the value of β may also be designated by using a certain learning algorithm, for example, the value of β is first set to a value (such as 0.8), and a loss in a certain period is calculated; and then, the value of β is designated to another value (such as 0.9), and a loss within a certain period is calculated. β with a minimum loss within all periods is used as an optimal value.

The advertising platform generates the policy file based on the obtained advertising network distribution.

The procedure for updating the network information by the advertising platform is as follows, that is, the advertising platform may update the advertising network according to a requirement of the user, and specifically, the user may change. For example, the advertising network ADN3 to an advertising network ADN4 by using an operation interface, that is, the advertising networks are ADN1, ADN2, and ADN3 before the change, and the advertising networks are ADN1, ADN2, and ADN4 after the change. After the advertising network is updated, an initial value of the allocation proportion may be manually set. For example, an allocation proportion of ADN1 is set to be 0.4, an allocation proportion of ADN2 is set to be 0.4, and an allocation proportion of ADN4 is set to be 0.2. The initial value may also be automatically generated by a system, for example, allocation proportions of ADN1, ADN2, and ADN4 are all set to ⅓.

New related information about the advertising network (including information such as the delivery proportion, an advertising network interface, and an advertising network name) is recorded in a new delivery policy. In addition, the advertising platform may generate a policy file according to the new delivery policy and send and synchronize the policy file to the client, so that the client performs advertisement delivery according to the new delivery policy.

In the embodiment of the present invention, the first user operation information includes any one of or a combination of the following: the number of times that an advertisement in an advertising network is displayed, the number of times that an advertisement in an advertising network is clicked, the click through rate of an advertisement in an advertising network, the number of times that an advertising network is selected, the number of times that an advertising network is clicked, and a click through rate of an advertising network.

It should be understood that, each parameter or the information listed above is only exemplary descriptions of the present invention, and the present invention is not limited thereto.

According to the advertisement delivery method in the embodiment of the present invention, an advertising platform can optimize a distribution of advertising networks, so that a delivery policy of an advertising network is rationalized.

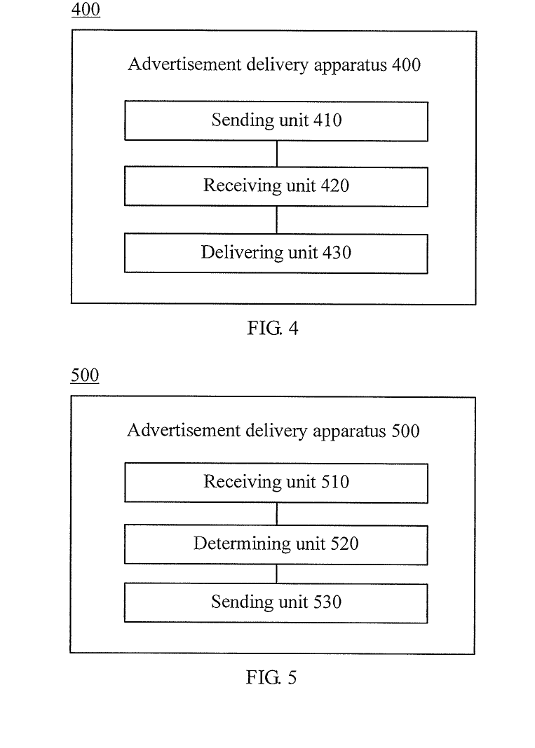

In the foregoing, the advertisement delivery methods according to the embodiments of the present invention are described in detail with reference to FIG. 1 to FIG. 3, and in the following, an advertisement delivery apparatus according to an embodiment of the present invention is described in detail with reference to FIG. 4 to FIG. 6.

FIG. 4 shows a schematic block diagram of an advertisement delivery apparatus 400 according to an embodiment of the present invention, which is described from the perspective of a user. As shown in FIG. 4, the apparatus 400 includes:

a sending unit 410, configured to send a first message including user information to an advertising platform;

a receiving unit 420, configured to receive a second message sent by the advertising platform, where the second message includes delivery information that is determined by the advertising platform according to the user information; and

a delivering unit 430, configured to perform advertisement delivery according to the delivery information.

In the embodiment of the present invention, the advertising platform may directly send a policy file to a client, so that the client selects an advertising network according to the policy file, and obtains an advertisement from the selected advertising network (case 7); the advertising platform may also select one advertising network according to the policy file, and send an interface file of the advertising network to the client, so that the client directly obtains an advertisement from the advertising network corresponding to the interface file (case 8); the advertising platform may further select one advertising network according to the policy file, obtain at least two advertisements from the advertising network, and notify the client of an allocation proportion of advertisement display traffic in each advertisement, so that the client delivers an advertisement according to the allocation proportion (case 9). These three cases are described respectively in the following.

Case 7

Optionally, in the embodiment of the present invention, the delivering unit 430 is specifically configured to determine a first delivery advertising network from at least two candidate advertising networks according to network information and first allocation information that are included in the delivery information, and obtain at least one advertisement from the first delivery advertising network to perform delivery, where the network information is used to indicate the at least two candidate advertising networks, the first allocation information is used to indicate allocation proportions of advertisement display traffic in the at least two candidate advertising networks, and the network information and the first allocation information are determined by the advertising platform according to the user information.

According to the advertisement delivery apparatus in the embodiment of the present invention, an advertising network is selected with reference to user information, so that a selected advertising network can meet a preference of a user, thereby implementing personalized advertising network allocation.

Optionally, in the embodiment of the present invention, the delivering unit 430 is further configured to obtain first user operation information;

configured to update the first allocation information according to the first user operation information; and

configured to determine a second delivery advertising network from the candidate advertising networks according to the network information and the updated first allocation information, and obtain at least one advertisement from the second delivery advertising network.

According to the advertisement delivery apparatus in the embodiment of the present invention, a client updates information, such as a delivery proportion of an advertising network, in real time, so that a selected advertising network can meet a preference of a user in real time, thereby implementing personalized advertising network allocation.

Optionally, in the embodiment of the present invention, the sending unit 410 is further configured to send a third message to the advertising platform, where the third message includes the first user operation information and the user information, so that the advertising platform updates the network information and/or the first allocation information according to the first user operation information and the user information.

According to the advertisement delivery apparatus in the embodiment of the present invention, an advertising platform updates information, such as a delivery proportion of an advertising network, according to user information, so that a selected advertising network can meet a preference of a user in real time, thereby implementing personalized advertising network allocation.

In the embodiment of the present invention, the first user operation information includes any one of or a combination of the following: the number of times that an advertisement in an advertising network is displayed, the number of times that an advertisement in an advertising network is clicked, a click through rate of an advertisement in an advertising network, the number of times that an advertising network is selected, the number of times that an advertising network is clicked, and a click through rate of an advertising network.

It should be understood that, each parameter or the information listed above is only exemplary descriptions of the present invention, and the present invention is not limited thereto.

Case 8

Optionally, in the embodiment of the present invention, the delivering unit 430 is specifically configured to obtain, according to an interface file included in the delivery information and used to indicate a third delivery advertising network, at least one advertisement from the third delivery advertising network to perform delivery, where the third delivery advertising network is determined by the advertising platform from at least two candidate advertising networks according to network information and first allocation information, the network information is used to indicate the at least two candidate advertising networks, the first allocation information is used to indicate allocation proportions of advertisement display traffic in the at least two candidate advertising networks, and the network information and the first allocation information are determined by the advertising platform according to the user information.

According to the advertisement delivery apparatus in the embodiment of the present invention, an advertising network is selected with reference to user information, so that a selected advertising network can meet a preference of a user, thereby implementing personalized advertising network allocation.

Optionally, in the embodiment of the present invention, the delivering unit 430 is further configured to obtain second user operation information; and

the sending unit 410 is further configured to send a fourth message including the second user operation information and the user information to the advertising platform, so that the advertising platform updates the network information and/or the first allocation information according to the second user operation information and the user information.

According to the advertisement delivery apparatus in the embodiment of the present invention, an advertising platform updates information, such as a delivery proportion of an advertising network, according to user information, so that a selected advertising network can meet a preference of a user in real time, thereby implementing personalized advertising network allocation.

Case 9

Optionally, in the embodiment of the present invention, the delivering unit 430 is specifically configured to obtain, according to advertisement information and second allocation information that are included in the delivery information, at least one advertisement from at least two advertisements to perform delivery, where the advertisement information is used to indicate the at least two advertisements, the second allocation information is used to indicate allocation proportions of advertisement display traffic in the at least two advertisements. The advertisement information and the second allocation information are determined by the advertising platform according to network information and first allocation information. The network information is used to indicate at least two candidate advertising networks, and the first allocation information is used to indicate allocation proportions of the advertisement display traffic in the at least two candidate advertising networks. The network information and the first allocation information are determined by the advertising platform according to the user information.

According to the advertisement delivery apparatus in the embodiment of the present invention, an advertisement is selected with reference to user information, so that the selected advertisement can meet a preference of a user, thereby implementing personalized advertising network allocation, and a client does not need to establish a connection to an advertising network, thereby reducing an impact on user performance.

Optionally, in the embodiment of the present invention, the delivering unit 430 is further configured to obtain second user operation information; and

the sending unit 410 is further configured to send a fourth message including the second user operation information and the user information to the advertising platform, so that the advertising platform updates the network information and/or the first allocation information according to the second user operation information and the user information.

According to the advertisement delivery apparatus in the embodiment of the present invention, an advertising platform updates information, such as a delivery proportion of an advertising network, according to user information, so that a selected advertising network can meet a preference of a user in real time, thereby implementing personalized advertising network allocation.

In the embodiment of the present invention, the second user operation information includes any one of or a combination of the following: the number of times that an advertisement is displayed, the number of times that an advertisement is clicked, a click through rate of an advertisement, and information about an advertising network to which an advertisement belongs.

Optionally, in the embodiment of the present invention, the apparatus further includes:

a storing unit, configured to store, in an advertisement database, the advertisement that is obtained according to the delivery information.

It should be noted that, the advertisement database may be stored in the client, or may be stored in another entity, and a specific location of the advertisement database is not limited in the embodiment of the present invention.

Optionally, the delivering unit 430 is further configured to obtain at least one advertisement from the advertisement database to perform delivery.

According to the apparatus in the embodiment of the present invention, when the advertisement needs to be delivered next time (for example, an application is started), the client may directly select an advertisement from a local advertisement database to perform delivery, thereby reducing an impact on user performance.

In the embodiment of the present invention, the user information may include any one of or a combination of the following: a user age, a user gender, a user location, and a user identifier.

The advertisement delivery apparatus 400 according to the embodiment of the present invention may correspond to the client in the method in the embodiment of the present invention, and the other operations and/or functions of the units and modules in the advertisement delivery apparatus 400 are respectively for implementing corresponding procedures in the method 100 in FIG. 1, which are not described herein gain for brevity.

FIG. 5 shows a schematic block diagram of an advertisement delivery apparatus 500 according to an embodiment of the present invention, which is described from the perspective of an advertising platform. As shown in FIG. 5, the apparatus 500 includes:

a receiving unit 510, configured to receive a first message that is sent by a client and includes user information;

a determining unit 520, configured to determine network information and first allocation information according to the user information, where the network information is used to indicate at least two candidate advertising networks, and the first allocation information is used to indicate allocation proportions of advertisement display traffic in the at least two candidate advertising networks; and

configured to determine delivery information according to the network information and the first allocation information; and

a sending unit 530, configured to send a second message including the delivery information to the client, so that the client performs advertisement delivery according to the delivery information.

In the embodiment of the present invention, the advertising platform may directly send a policy file to the client (case 10); the advertising platform may also select by itself one advertising network according to the delivery policy and according to candidate advertising networks and a traffic allocation proportion that are recorded in the delivery policy, generate an interface file of the advertising network, and send the interface file to the client (case 11); and the advertising platform may further select one advertising network according to the policy file, and obtain at least two advertisements from the advertising network, and notify the client of an allocation proportion of the advertisement display traffic in each advertisement, so that the client delivers an advertisement according to the allocation proportion (case 12). These three cases are described respectively in the following.

Case 10

Optionally, in the embodiment of the present invention, the determining unit 520 is specifically configured to determine, according to the network information and the first allocation information, delivery information including the network information and the first allocation information.

According to the advertisement delivery apparatus in the embodiment of the present invention, an advertising network is selected with reference to user information, so that a selected advertising network can meet a preference of a user, thereby implementing personalized advertising network allocation.

Optionally, in the embodiment of the present invention, the receiving unit 510 is further configured to receive a third message that is sent by the client and includes first user operation information and the user information; and

the determining unit 520 is further configured to update the network information and/or the first allocation information according to the first user operation information and the user information.

According to the advertisement delivery apparatus in the embodiment of the present invention, an advertising platform updates information, such as a delivery proportion of an advertising network, according to user information, so that a selected advertising network can meet a preference of a user in real time, thereby implementing personalized advertising network allocation.

In the embodiment of the present invention, the first user operation information includes any one of or a combination of the following: the number of times that an advertisement in an advertising network is displayed, the number of times that an advertisement in an advertising network is clicked, a click through rate of an advertisement in an advertising network, the number of times that an advertising network is selected, the number of times that an advertising network is clicked, and a click through rate of an advertising network.

Case 11

Optionally, in the embodiment of the present invention, the determining unit 520 is further configured to determine a third delivery advertising network from the at least two candidate advertising networks according to the network information and the first allocation information; and

configured to determine delivery information including an interface file, where the interface file is used to indicate the third delivery advertising network.

According to the advertisement delivery apparatus in the embodiment of the present invention, an advertising network is selected with reference to user information, so that a selected advertising network can meet a preference of a user, thereby implementing personalized advertising network allocation.

Optionally, in the embodiment of the present invention, the receiving unit 510 is further configured to receive a fourth message that is sent by the user and includes second user operation information and the user information; and

the determining unit 520 is further configured to update the network information and/or the first allocation information according to the second user operation information and the user information.

According to the advertisement delivery apparatus in the embodiment of the present invention, an advertising platform updates information, such as a delivery proportion of an advertising network, according to user information, so that a selected advertising network can meet a preference of a user in real time, thereby implementing personalized advertising network allocation.

In the embodiment of the present invention, the second user operation information includes any one of or a combination of the following: the number of times that an advertisement is displayed, the number of times that an advertisement is clicked, and a click through rate of an advertisement.

Case 12

Optionally, in the embodiment of the present invention, the determining unit 520 is specifically configured to determine a fourth delivery advertising network from the at least two candidate advertising networks according to the network information and the first allocation information, and obtain at least two advertisements from the fourth delivery advertising network; and

configured to determine allocation proportions of the advertisement display traffic in the at least two advertisements according to the first allocation information; and configured to determine delivery information including advertisement information and second allocation information, where the advertisement information is used to indicate the at least two advertisements, and the second allocation information is used to indicate the allocation proportions of the advertisement display traffic in the at least two advertisements.

According to the advertisement delivery apparatus in the embodiment of the present invention, an advertisement is selected with reference to user information, so that the selected advertisement can meet a preference of a user, thereby implementing personalized advertising network allocation, and a client does not need to establish a connection to an advertising network, thereby reducing an impact on user performance.

In the embodiment of the present invention, the receiving unit 510 is further configured to receive a fourth message that is sent by the client and includes second user operation information and the user information; and

the determining unit 520 is further configured to update the network information and/or the first allocation information according to the second user operation information and the user information.

According to the advertisement delivery apparatus in the embodiment of the present invention, an advertising platform updates information, such as a delivery proportion of an advertising network, according to user information, so that a selected advertising network can meet a preference of a user in real time, thereby implementing personalized advertising network allocation.

In the embodiment of the present invention, the second user operation information includes any one of or a combination of the following: the number of times that an advertisement is displayed, the number of times that an advertisement is clicked, and a click through rate of an advertisement.

In the embodiment of the present invention, the user information includes any one of or a combination of the following: a user age, a user gender, a user location, and a user identifier.

The advertisement delivery apparatus 500 according to the embodiment of the present invention may correspond to the advertising platform in the method in the embodiment of the present invention, and the other operations and/or functions of the units and modules in the advertisement delivery apparatus 500 are respectively for implementing corresponding procedures in the method 200 in FIG. 2, which are not described herein gain for brevity.

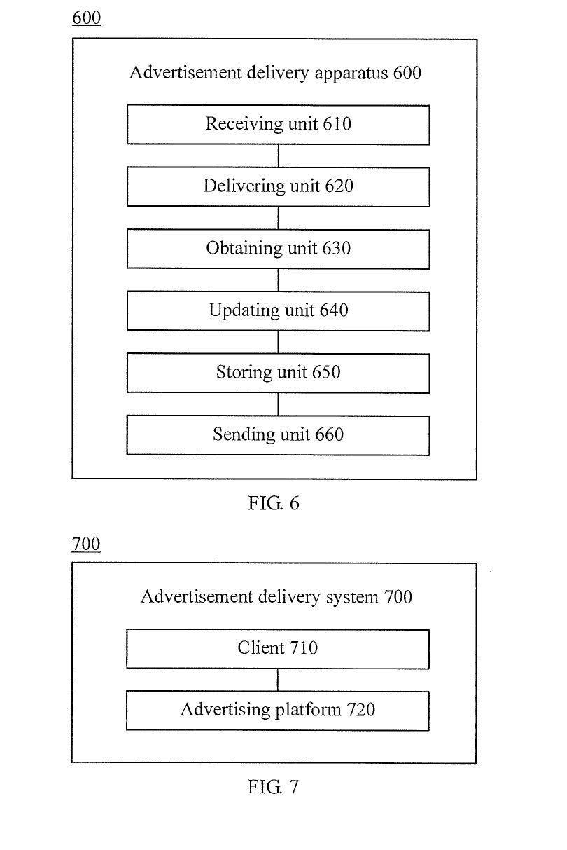

FIG. 6 shows a schematic block diagram of an advertisement delivery apparatus 600 according to an embodiment of the present invention, which is described from the perspective of a client. As shown in FIG. 6, the apparatus 600 includes:

a receiving unit 610, configured to receive a delivery request message sent by an advertising platform, where the delivery request message includes network information and first allocation information, and the network information and first allocation information are determined by the advertising platform. The network information is used to indicate at least two candidate advertising networks, and the first allocation information is used to indicate allocation proportions of advertisement display traffic in the at least two candidate advertising networks;

a delivering unit 620, configured to determine an initial delivery advertising network from the at least two candidate advertising networks according to the network information and the first allocation information, and obtain at least one advertisement from the initial delivery advertising network to perform delivery;

an obtaining unit 630, configured to obtain first user operation information; and

an updating unit 640, configured to update the first allocation information according to the first user operation information;

the delivering unit 620 is further configured to determine an updated delivery advertising network from the at least two candidate advertising networks according to the network information and the updated first allocation information, and obtain at least one advertisement from the updated delivery advertising network to perform delivery.

According to the advertisement delivery apparatus in the embodiment of the present invention, a client updates information, such as a delivery proportion of an advertising network, in real time, and the advertising network can be selected with reference to user information, so that the selected advertising network meets a preference of a user in real time, thereby implementing personalized advertising network allocation.

Optionally, the apparatus may further include a storing unit 650, configured to store, in an advertisement database, the advertisement obtained from the updated delivery advertising network.

It should be noted that, the advertisement database may be stored in the client, or may be stored in another entity, and a specific location of the advertisement database is not limited in the embodiment of the present invention.

Optionally, in this embodiment, the delivering unit 620 is further configured to obtain at least one advertisement from the advertisement database to perform delivery.

According to the apparatus in the embodiment of the present invention, when the advertisement needs to be delivered next time (for example, an application is started), the client may directly select an advertisement from a local advertisement database to perform delivery, thereby reducing an impact on user performance.

Optionally, in the embodiment of the present invention, the apparatus further includes:

a sending unit 660, configured to send a feedback message including the first user operation information to the advertising platform, so that the advertising platform updates the network information and/or the first allocation information according to the first user operation information.

According to the advertisement delivery apparatus in the embodiment of the present invention, an advertising platform can optimize a distribution of advertising networks, so that a delivery policy of an advertising network is rationalized.

In the embodiment of the present invention, the first user operation information includes any one of or a combination of the following: the number of times that an advertisement in the advertising network is displayed, the number of times that an advertisement in the advertising network is clicked, a click through rate of an advertisement in the advertising network, the number of times that an advertising network is selected, the number of times that an advertising network is clicked, and a click through rate of an advertising network.

The advertisement delivery apparatus 600 according to the embodiment of the present invention may correspond to the client in the method in the embodiment of the present invention, and the other operations and/or functions of the units and modules in the advertisement delivery apparatus 600 are respectively for implementing corresponding procedures in the method 300 in FIG. 3, which are not described herein gain for brevity.

In the embodiment of the present invention described above, the client may obtain one advertisement or may obtain more than two advertisements from the advertising network, which is not particularly limited in the present invention.

FIG. 7 shows a schematic block diagram of an advertisement delivery system according to an embodiment of the present invention. As shown in FIG. 7, the advertisement delivery system includes: a client 710 and an advertising platform 720, where the client 710 includes: a sending unit, configured to send a first message including user information to the advertising platform; a receiving unit, configured to receive a second message sent by the advertising platform, where the second message includes delivery information that is determined by the advertising platform according to the user information; and a delivering unit, configured to perform advertisement delivery according to the delivery information. The advertising platform 720 includes: a receiving unit, configured to receive the first message sent by the client and including the user information; a determining unit, configured to determine network information and first allocation information according to the user information, where the network information is used to indicate at least two candidate advertising networks, and the first allocation information is used to indicate allocation proportions of advertisement display traffic in the at least two candidate advertising networks; and configured to determine the delivery information according to the network information and the first allocation information; and a sending unit, configured to send the second message including the delivery information to the client, so that the client performs advertisement delivery according to the delivery information.

According to the advertisement delivery system in the embodiment of the present invention, an advertising network is selected with reference to user information, so that a selected advertising network can meet a preference of a user, thereby implementing personalized advertising network allocation.

It should be understood that, in this document, the term “and/or” is only an association relationship for describing associated objects, and represents that three relationships may exist, for example, A and/or B may represent the following three cases: A exists separately, A and B exist at the same time, and B exists separately. In addition, the symbol “I” in this document usually represents that associated objects before and after the symbol are in an “or” relationship. It should be understood that, in the embodiment of the present invention, the terms “first delivery advertising network”, “second delivery advertising network”, “third delivery advertising network”, “fourth delivery advertising network”, “initial delivery advertising network”, and “updated delivery advertising network” are all networks for delivering an advertisement, and for the ease of understanding, use different names, and may be a same advertising network or may be different advertising networks, which is not limited in the present invention.

It should be understood that, sequence numbers of the foregoing processes do not indicate execution sequences in various embodiments of the present invention. The execution sequences of the processes should be determined according to functions and internal logic of the processes, and should not be construed as any limitation to the implementation processes of the embodiments of the present invention.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, which is not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of the present invention essentially, or the part contributing to the prior art, or a part of the technical solutions may be implemented in a form of a software product. The computer software product is stored in a storage medium, and includes several instructions for instructing a computer device (which may be a personal computer, a server, a network device, or the like) to perform all or a part of the steps of the methods described in the embodiments of the present invention. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. An advertisement delivery method executed in a client, the method comprising:
sending a first message comprising user information to an advertising platform;
receiving a second message sent by the advertising platform, wherein the second message comprises delivery information determined by the advertising platform according to the user information; and
performing advertisement delivery according to the delivery information.

2. The method according to claim 1, wherein performing advertisement delivery according to the delivery information comprises:
determining a first delivery advertising network from at least two candidate advertising networks according to network information and first allocation information that are comprised in the delivery information, and obtaining at least one advertisement from the first delivery advertising network to perform delivery, wherein the network information is used to indicate the at least two candidate advertising networks, the first allocation information is used to indicate allocation proportions of advertisement display traffic in the at least two candidate advertising networks, and the network information and the first allocation information are determined by the advertising platform according to the user information.

3. The method according to claim 2, wherein after obtaining at least one advertisement from the first delivery advertising network to perform delivery, the method further comprises:
obtaining first user operation information;
updating the first allocation information according to the first user operation information; and
determining a second delivery advertising network from the at least two candidate advertising networks according to the network information and the updated first allocation information, and obtaining at least one advertisement from the second delivery advertising network to perform delivery.

4. The method according to claim 3, wherein after obtaining first user operation information, the method further comprises:
sending a third message to the advertising platform, wherein the third message comprises the first user operation information and the user information, so that the advertising platform updates the network information and/or the first allocation information according to the first user operation information and the user information.

5. The method according to claim 3, wherein the first user operation information comprises at least one of the following: a number of times that an advertisement in an advertising network is displayed, a number of times that an advertisement in an advertising network is clicked, a click through rate of an advertisement in an advertising network, a number of times that an advertising network is selected, a number of times that an advertising network is clicked, and a click through rate of an advertising network.

6. The method according to claim 1, wherein performing advertisement delivery according to the delivery information comprises:
obtaining, according to an interface file comprised in the delivery information and used to indicate a third delivery advertising network, at least one advertisement from the third delivery advertising network to perform delivery, wherein the third delivery advertising network is determined by the advertising platform from at least two candidate advertising networks according to network information and first allocation information, the network information is used to indicate the at least two candidate advertising networks, the first allocation information is used to indicate allocation proportions of advertisement display traffic in the at least two candidate advertising networks, and the network information and the first allocation information are determined by the advertising platform according to the user information.

7. The method according to claim 6, further comprising:
obtaining second user operation information; and
sending a fourth message to the advertising platform, wherein the fourth message comprises the second user operation information and the user information, so that the advertising platform updates the network information and/or the first allocation information according to the second user operation information and the user information.

8. The method according to claim 7, wherein the second user operation information comprises at least one of the following: a number of times that an advertisement is displayed, a number of times that an advertisement is clicked, a click through rate of an advertisement, and information about an advertising network to which an advertisement belongs.

9. The method according to claim 1, wherein performing advertisement delivery according to the delivery information comprises:
obtaining, according to advertisement information and second allocation information that are comprised in the delivery information, at least one advertisement from at least two advertisements to perform delivery, wherein the advertisement information is used to indicate the at least two advertisements, the second allocation information is used to indicate allocation proportions of advertisement display traffic in the at least two advertisements, the advertisement information and the second allocation information are determined by the advertising platform according to network information and first allocation information, the network information is used to indicate at least two candidate advertising networks, the first allocation information is used to indicate allocation proportions of the advertisement display traffic in the at least two candidate advertising networks, and the network information and the first allocation information are determined by the advertising platform according to the user information.

10. The method according to claim 9, further comprising:
obtaining second user operation information; and
sending a fourth message to the advertising platform, wherein the fourth message comprises the second user operation information and the user information, so that the advertising platform updates the network information and/or the first allocation information according to the second user operation information and the user information.

11. The method according to claim 10, wherein the second user operation information comprises at least one of the following: a number of times that an advertisement is displayed, a number of times that an advertisement is clicked, a click through rate of an advertisement, and information about an advertising network to which an advertisement belongs.

12. The method according to claim 1, wherein the user information comprises at least one of the following: a user age, a user gender, a user location, and a user identifier.

13. An advertisement delivery method executed in an advertising platform, the method comprising:
receiving a first message sent by a client and comprising user information;
determining network information and first allocation information according to the user information, wherein the network information is used to indicate at least two candidate advertising networks, and the first allocation information is used to indicate allocation proportions of advertisement display traffic in the at least two candidate advertising networks;
determining delivery information according to the network information and the first allocation information; and
sending a second message comprising the delivery information to the client, so that the client performs advertisement delivery according to the delivery information.

14. The method according to claim 13, wherein determining delivery information according to the network information and the first allocation information comprises:
determining, according to the network information and the first allocation information, the delivery information comprising the network information and the first allocation information.

15. The method according to claim 14, wherein after sending a second message comprising the delivery information to the client, the method further comprises:
receiving a third message sent by the client and comprising first user operation information and the user information; and
updating the network information and/or the first allocation information according to the first user operation information and the user information.

16. The method according to claim 15, wherein the first user operation information comprises at least one of the following: a number of times that an advertisement in an advertising network is displayed, a number of times that an advertisement in an advertising network is clicked, a click through rate of an advertisement in an advertising network, a number of times that an advertising network is selected, a number of times that an advertising network is clicked, and a click through rate of an advertising network.

17. The method according to claim 13, wherein determining delivery information according to the network information and the first allocation information comprises:
determining a third delivery advertising network from the at least two candidate advertising networks according to the network information and the first allocation information; and
determining the delivery information comprising an interface file, wherein the interface file is used to indicate the third delivery advertising network.

18. The method according to claim 17, wherein after sending a second message comprising the delivery information to the client, the method further comprises:
receiving a fourth message sent by the client and comprising second user operation information and the user information; and
updating the network information and/or the first allocation information according to the second user operation information and the user information.

19. The method according to claim 18, wherein the second user operation information comprises at least one of the following: a number of times that an advertisement is displayed, a number of times that an advertisement is clicked, a click through rate of an advertisement, and information about an advertising network to which an advertisement belongs.

20. The method according to claim 13, wherein determining delivery information according to the network information and the first allocation information comprises:
determining a fourth delivery advertising network from the at least two candidate advertising networks according to the network information and the first allocation information;
obtaining at least two advertisements from the fourth delivery advertising network;
determining allocation proportions of the advertisement display traffic in the at least two advertisements according to the first allocation information; and
determining the delivery information comprising advertisement information and second allocation information, wherein the advertisement information is used to indicate the at least two advertisements, and the second allocation information is used to indicate the allocation proportions of the advertisement display traffic in the at least two advertisements.

21. The method according to claim 20, wherein after sending a second message comprising the delivery information to the client, the method further comprises:
receiving a fourth message sent by the client and comprising second user operation information and the user information; and
updating the network information and/or the first allocation information according to the second user operation information and the user information.

22. The method according to claim 21, wherein the second user operation information comprises at least one of the following: a number of times that an advertisement is displayed, a number of times that an advertisement is clicked, a click through rate of an advertisement, and information about an advertising network to which an advertisement belongs.

23. The method according to claim 13, wherein the user information comprises at least one of the following: a user age, a user gender, a user location, and a user identifier.

24. An advertisement delivery apparatus, comprising:
a sending unit, configured to send a first message comprising user information to an advertising platform;
a receiving unit, configured to receive a second message sent by the advertising platform, wherein the second message comprises delivery information that is determined by the advertising platform according to the user information; and
a delivering unit, configured to perform advertisement delivery according to the delivery information.

25. The apparatus according to claim 24, wherein the delivering unit is configured to determine a first delivery advertising network from at least two candidate advertising networks according to network information and first allocation information that are comprised in the delivery information, and obtain at least one advertisement from the first delivery advertising network to perform delivery, wherein the network information is used to indicate the at least two candidate advertising networks, the first allocation information is used to indicate allocation proportions of advertisement display traffic in the at least two candidate advertising networks, and the network information and the first allocation information are determined by the advertising platform according to the user information.

26. The apparatus according to claim 25, wherein the delivering unit is further configured to obtain first user operation information, update the first allocation information according to the first user operation information, and determine a second delivery advertising network from the at least two candidate advertising networks according to the network information and the updated first allocation information, and obtain at least one advertisement from the second delivery advertising network to perform delivery.

27. The apparatus according to claim 26, wherein the sending unit is further configured to send a third message to the advertising platform, wherein the third message comprises the first user operation information and the user information, so that the advertising platform updates the network information and/or the first allocation information according to the first user operation information and the user information.

28. The apparatus according to claim 24, wherein the delivering unit is configured to obtain, according to an interface file comprised in the delivery information and used to indicate a third delivery advertising network, at least one advertisement from the third delivery advertising network to perform delivery, wherein the third delivery advertising network is determined by the advertising platform from at least two candidate advertising networks according to network information and first allocation information, the network information is used to indicate the at least two candidate advertising networks, the first allocation information is used to indicate allocation proportions of advertisement display traffic in the at least two candidate advertising networks, and the network information and the first allocation information are determined by the advertising platform according to the user information.

29. The apparatus according to claim 28, wherein the delivering unit is further configured to obtain second user operation information; and
the sending unit is further configured to send a fourth message to the advertising platform, wherein the fourth message comprises the second user operation information and the user information, so that the advertising platform updates the network information and/or the first allocation information according to the second user operation information and the user information.

30. The apparatus according to claim 24, wherein the delivering unit is configured to obtain, according to advertisement information and second allocation information that are comprised in the delivery information, at least one advertisement from at least two advertisements to perform delivery, wherein the advertisement information is used to indicate the at least two advertisements, the second allocation information is used to indicate allocation proportions of advertisement display traffic in the at least two advertisements, the advertisement information and the second allocation information are determined by the advertising platform according to network information and first allocation information, the network information is used to indicate at least two candidate advertising networks, the first allocation information is used to indicate allocation proportions of the advertisement display traffic in the at least two candidate advertising networks, and the network information and the first allocation information are determined by the advertising platform according to the user information.

31. The apparatus according to claim 30, wherein the delivering unit is further configured to obtain second user operation information; and
the sending unit is further configured to send a fourth message to the advertising platform, wherein the fourth message comprises the second user operation information and the user information, so that the advertising platform updates the network information and/or the first allocation information according to the second user operation information and the user information.

32. An advertisement delivery apparatus, comprising:
a receiving unit, configured to receive a first message sent by a client and comprising user information;
a determining unit, configured to:
determine network information and first allocation information according to the user information, wherein the network information is used to indicate at least two candidate advertising networks, and the first allocation information is used to indicate allocation proportions of advertisement display traffic in the at least two candidate advertising networks, and
determine delivery information according to the network information and the first allocation information; and
a sending unit, configured to send a second message comprising the delivery information to the client, so that the client performs advertisement delivery according to the delivery information.

33. The apparatus according to claim 32, wherein the determining unit is configured to determine, according to the network information and the first allocation information, the delivery information comprising the network information and the first allocation information.

34. The apparatus according to claim 33, wherein:
the receiving unit is further configured to receive a third message sent by the client and comprising first user operation information and the user information; and
the determining unit is further configured to update the network information and/or the first allocation information according to the first user operation information and the user information.

35. The apparatus according to claim 32, wherein the determining unit is configured to:
determine a third delivery advertising network from the at least two candidate advertising networks according to the network information and the first allocation information; and
determine the delivery information comprising an interface file, wherein the interface file is used to indicate the third delivery advertising network.

36. The apparatus according to claim 35, wherein:
the receiving unit is further configured to receive a fourth message sent by the client and comprising second user operation information and the user information; and
the determining unit is further configured to update the network information and/or the first allocation information according to the second user operation information and the user information.

37. The apparatus according to claim 32, wherein the determining unit is configured to:
determine a fourth delivery advertising network from the at least two candidate advertising networks according to the network information and the first allocation information, and obtain the at least two advertisements from the fourth delivery advertising network;
determine allocation proportions of the advertisement display traffic in the at least two advertisements according to the first allocation information; and
determine the delivery information comprising advertisement information and second allocation information, wherein the advertisement information is used to indicate the at least two advertisements, and the second allocation information is used to indicate the allocation proportions of the advertisement display traffic in the at least two advertisements.

38. The apparatus according to claim 37, wherein:
the receiving unit is further configured to receive a fourth message sent by the client and comprising second user operation information and the user information; and
the determining unit is further configured to update the network information and/or the first allocation information according to the second user operation information and the user information.
